(19) United States
(12) Patent Application Publication
(10) Pub. No.: US 2026/0277667 A1
(43) Pub. Date: Sep. 17, 2026

(54) TASK AGNOSTIC PLANNING AND EXECUTION OF AGENT WORKFLOWS

(71) Applicant: NVIDIA Corporation, Santa Clara, CA (US)

(72) Inventors: Rachel Allen, Arlington, VA (US); Michael David Demoret, Brooklyn, NY (US); Dhruv Nandakumar, Boston, MA (US)

(21) Appl. No.: 19/358,849

(22) Filed: Oct. 15, 2025

Related U.S. Application Data
(60) Provisional application No. 63/772,590, filed on Mar. 16, 2025.

(51) Int. Cl. G06F 9/48; G06N 5/043

(52) U.S. Cl. CPC G06F 9/4881; G06N 5/043

(57) ABSTRACT

An artificial intelligence (AI) agent system controls the processing of user requests by receiving function descriptions for various AI agent workflows, instructing a reasoning model to generate an execution plan based on the request and workflows, and then causing the workflows to process the request according to the generated plan.

### CROSS-REFERENCE TO RELATED APPLICATION

This application is a non-provisional of and claims priority to U.S. Provisional Application No. 63/772,590, filed Mar. 16, 2025, which is incorporated by reference herein in its entirety.

### TECHNICAL FIELD

This disclosure generally relates to AI agent workflow (e.g., artificial intelligence (AI) and/or language model (LM)) evaluation systems, and more particularly to computer-implemented architectures that facilitate intelligent assessment of AI/LM agent and/or AI agent workflow performance across multiple frameworks.

### BACKGROUND

Reasoning model integration mechanisms for AI agent workflows suffer from technical constraints that impede the advancement of scalable agentic planning systems. Current frameworks for building and deploying AI agents support individual model integration during development, but they are bottlenecked by limitations that prevent generalized reasoning wrapper functionality across heterogeneous workflow architectures. These frameworks only work for agents where reasoning and instruction-following capabilities are manually hardcoded within their specific environment, making it challenging for developers to implement planning-execution separation across multiple agent implementations, such as LangChain, LlamaIndex, CrewAI, and Semantic Kernel. This creates fragmented development approaches where developers cannot obtain unified reasoning integration across diverse AI agent architectures, resulting in repeated custom implementations and suboptimal resource utilization decisions.

The technical problem extends beyond framework-specific implementations into the realm of workflow introspection, where current development approaches focus primarily on static tool integration and manual prompt engineering without addressing dynamic function discovery, automatic type conversion, and workflow-agnostic planning capabilities. Traditional frameworks only consider predetermined tool configurations, failing to account for the complex abstraction requirements that emerge when reasoning models need to generate execution plans for arbitrary workflow compositions. With large AI agentic systems where different agents may utilize different tool sets and execution patterns, it becomes difficult to implement generalizable planning mechanisms when only specific agent configurations are supported during individual development cycles.

The technical constraints further manifest in the inability to perform workflow-agnostic reasoning wrapper deployment, where developers may need to manually iterate through time-consuming cycles of prompt engineering, tool description management, and execution plan generation across disparate agent implementations. This manual intervention creates a development bottleneck as reasoning integration parameters such as model selection, function introspection strategies, and plan generation patterns need to be individually implemented without standardized abstractions or unified configuration capabilities. The lack of automated, framework-agnostic reasoning wrapper mechanisms forces developers to make integration decisions based on incomplete visibility into their workflow compositions, resulting in suboptimal token utilization, unnecessary development overhead, and non-transferable reasoning implementations when multiple agent workflows require planning capabilities across different framework environments simultaneously.

### BRIEF DESCRIPTION OF THE DRAWINGS

The present systems and methods are described in detail below with reference to the attached drawing figures. To easily identify the discussion of any particular element or act, the most significant digit or digits in a reference number refer to the figure number in which that element is first introduced. In the drawing figures:

FIG. 1 illustrates an AI agent system, according to at least some embodiments of the present disclosure.

FIG. 2 is an AI agent workflow diagram, according to at least some embodiments of the present disclosure.

FIG. 3 illustrates a task-agnostic reasoning wrapper system, according to at least some embodiments of the present disclosure.

FIG. 4 illustrates an evaluation system, according to at least some embodiments of the present disclosure.

FIG. 5 illustrates a reasoning model system, according to at least some embodiments of the present disclosure.

FIG. 6 is a flowchart illustrating an example method performed by the AI agent system, according to at least some embodiments of the present disclosure.

FIG. 7A is a diagram of an example generative language model system suitable for use in implementing at least some embodiments of the present disclosure.

FIG. 7B is a diagram of an example generative language model that includes a transformer encoder-decoder suitable for use in implementing at least some embodiments of the present disclosure.

FIG. 7C is a diagram of an example generative language model that includes a decoder-only transformer architecture suitable for use in implementing at least some embodiments of the present disclosure.

FIG. 8 is a diagram of an example computing device suitable for use in implementing at least some embodiments of the present disclosure.

FIG. 9 is a diagram of an example data center suitable for use in implementing at least some embodiments of the present disclosure.

### DETAILED DESCRIPTION

Systems and methods are disclosed related to task-agnostic planning and execution of AI agent workflows. Specifically, but not exclusively, this disclosure relates to AI agent workflow planning systems, and to computer-implemented architectures that facilitate automated execution plan generation and configurable reasoning wrapper deployment across, for example, multi-framework agent implementations in distributed computing environments.

The present disclosure provides systems and methods for implementing intelligent workflow-agnostic planning through an architecture that enables framework-agnostic function introspection and standardized execution plan generation for AI agent workflows regardless of their underlying implementation frameworks. The technology represents a significant advancement over conventional agent planning systems by creating a unified framework (e.g., an AI agent system or sometimes referred to as an AI agent toolkit or AI agent platform) where dynamic function inspection capabilities can automatically discover and analyze agent workflow components built across heterogeneous frameworks including LangChain, LlamaIndex, CrewAI, and/or Semantic Kernel while maintaining complete workflow transparency through standardized function registration and introspection mechanisms. The disclosed system supports comprehensive reasoning model integration that enables developers to separate planning operations from execution operations by automatically generating contextual execution plans using reasoning models and passing them to instruction-following models for efficient workflow execution. The architecture extends beyond simple workflow coordination to provide granular function-level reasoning wrapper deployment, automatic type conversion capabilities, and/or behavioral characteristic identification at a level of detail previously unavailable across multiple agent frameworks. This holistic approach enables optimization insights ranging from token efficiency through model separation and automated plan generation to workflow composition flexibility and configuration-driven reasoning deployment while maintaining developer workflow independence and supporting seamless integration with existing agent implementations through standardized wrapper mechanisms and dynamic function introspection capabilities.

In some embodiments, the disclosed techniques provide an AI agent system that receives function descriptions for AI agent workflows and leverages a reasoning model to generate execution plans based on user requests and the function descriptions. The AI agent system then causes the AI agent workflows to process user requests according to the execution plan generated by the reasoning model (e.g., a language model (LM)). The AI agent system enables function registration where developers define input schemas, output schemas, descriptions, and entry points for each function. This function information gets stored in a builder registry that maintains details about tools, agents, and functions used in the AI agent workflows. The AI agent system collects function registration data at build time from the stored function information to enable dynamic inspection of workflow components, providing the AI agent system with collected function registration data to enable reasoning operations based on comprehensive understanding of available workflow functions.

Agent functions can be wrapped with standardized interfaces that define standardized input schemas, output schemas, and descriptions of the AI agent workflows. These wrapped functions register with the AI agent system that maintains information about tools, agents, and functions across different AI agent frameworks used to create the workflows. The AI agent system inspects source code of AI agent workflows to identify undeclared agent frameworks and automatically discovers language model frameworks used in function definitions by analyzing code structure or library imports. Custom callback handlers register for each identified undeclared agent framework to intercept framework invocations. The AI agent system generates standardized data for AI agent workflows by extracting metadata including input data, output data, or token usage from intercepted framework invocations through the custom callback handlers. The extracted metadata gets normalized across different frameworks into a unified data model and published to an intermediate step stream.

For reasoning prompt construction, the AI agent system collects descriptions of AI agent workflows to generate agent objectives and analyzes available resources including tools and/or functions accessible to workflows through function registration data. A reasoning prompt gets constructed for the reasoning model that frames the user request within context of agent objectives and available resources, then passes the constructed reasoning prompt to the reasoning model for generating the execution plan. The AI agent system can automatically detect input and output data types of workflow functions and performs type conversions between outputs of the reasoning model and input data types of workflow functions while transforming output data types of the workflow functions.

Individual functions within AI agent workflows can be wrapped with reasoning capabilities. The system detects when an individual function has been wrapped with reasoning capabilities, generates a prompt for the reasoning model that includes a description of the individual function to generate the execution plan for that function, and causes selective application of reasoning to specific workflow components. Configuration options allow applying reasoning at multiple levels of workflow hierarchy.

Configuration files specify reasoning wrapper parameters without additional programming for AI agent workflows. The AI agent system parses configuration syntax of configuration files to select portions of workflow components for reasoning and applies reasoning wrappers automatically at runtime to selected workflow components before executing operations. The AI agent system can monitor execution of execution plans by AI agent workflows and detects execution results including errors or failures during execution plan execution. Feedback data gets generated from execution results and provided to the reasoning model for improving subsequent plan generation.

In some embodiments, a validation model can check logical consistency of execution plans before execution begins, analyzes execution plans for non-sequitur elements or logical errors, and routes invalid portions of execution plans back to the reasoning model to generate revised execution plans. Behavioral profiles of AI agent workflows get built through continuous monitoring of execution patterns. The AI agent system analyzes historical performance data to identify common failure scenarios or bottlenecks and incorporates behavioral profiles and historical performance data into prompt construction for the reasoning model to generate the execution plans.

The execution plan can include a structured execution sequence of actionable steps that break down user requests into specific tasks for execution by AI agent workflows. This includes a list of tools or functions to be called at multiple steps of the execution sequence along with corresponding input parameters, instructions for tool invocations including specific input types and expected outputs for each step in the execution plan, an order of execution steps and dependencies between different workflow components to accomplish the user request, and a roadmap that enables instruction-following models to execute the execution plan.

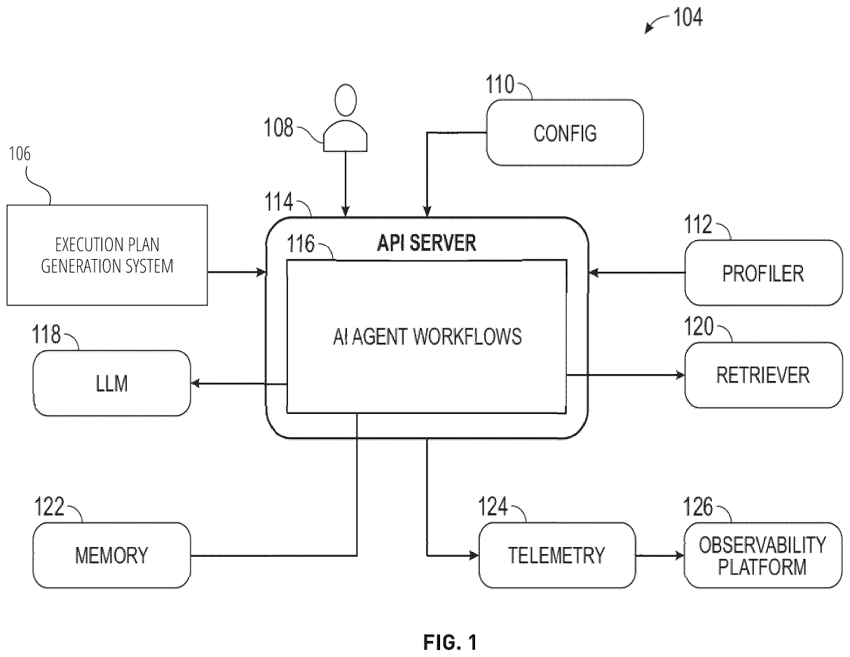

FIG. 1 illustrates a comprehensive AI agent system 104 that enables task-agnostic planning and execution of AI agent workflows 116 through automated reasoning wrapper deployment and execution plan generation across multiple implementation frameworks. It should be understood that this AI agent system 104 shown and described in FIG. 1 and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described below), one or more computing devices or components thereof (e.g., as described below, and/or one or more data centers or components thereof (e.g., as described below).

The AI agent system 104 provides a unified platform for integrating reasoning and instruction-following models regardless of whether the AI agent workflows 116 are implemented in LangChain, LlamaIndex, CrewAI, Semantic Kernel, and/or other agent frameworks. The architecture supports dynamic function introspection, automatic type conversion, and configuration-driven reasoning wrapper deployment while maintaining compatibility with existing agent development frameworks.

A central component API server 114 serves as the primary interface through which users interact with the AI agent system 104 for reasoning wrapper deployment and execution plan generation. This API server 114 component receives requests from developers seeking to wrap their agent workflows with reasoning capabilities and coordinates the dynamic function introspection, execution plan generation, and reasoning model integration operations across the AI agent system 104. The API server 114 provides standardized endpoints that allow developers to submit their AI agent workflows 116 for reasoning wrapper deployment without requiring modifications to their existing agent implementations.

In some embodiments, developers (user 108) may upload their workflows through multiple mechanisms, including direct code submission via REST API endpoints, configuration file uploads using YAML-based workflow definitions, and/or through integration with existing development environments where the API server 114 can access workflow repositories or containerized agent implementations. The API server 114 may implement both manual and/or automated framework detection capabilities to identify which agent frameworks are being used in submitted workflows. For manual detection, developers may explicitly declare the frameworks they are using through configuration parameters or metadata tags when submitting their workflows, such as specifying LangChain, LlamaIndex, CrewAI, Semantic Kernel, or other supported frameworks. The AI agent system 104 may provide standardized configuration templates that allow developers to indicate which frameworks power different components of their multi-framework agent implementations.

For automated framework detection, the API server 114 may coordinate with framework discovery components that inspect source code at build time to identify undeclared agent frameworks. This automated detection process may analyze code structure, library imports, function signatures, and dependency declarations to infer which agent frameworks are being used even when not explicitly declared by developers. The AI agent system 104 may employ pattern matching algorithms that recognize framework-specific coding patterns, API calls, and data structures characteristic of different agent frameworks. Once frameworks are identified through either manual declaration or automated discovery, the API server 114 may coordinate the registration of appropriate custom callback handlers for each detected framework, enabling comprehensive instrumentation and analysis capabilities across heterogeneous agent implementations.

A configuration 110 component stores and manages configuration parameters for reasoning wrapper deployment and execution plan generation. This configuration 110 component contains settings that define which workflows and/or functions of the AI agent workflows 116 should be wrapped with reasoning capabilities, which reasoning models should be used for different types of execution plans, and how type conversions should be handled between reasoning model outputs and workflow function inputs. The configuration 110 enables developers to specify reasoning wrapper parameters without additional programming, allowing transparent and configurable integration of reasoning and instruction-following models.

The AI agent workflows 116 may represent the target agent implementations that are being analyzed by the system. These AI agent workflows 116 may be implemented using any combination of supported agent frameworks and may contain complex hierarchies of agents, tools, and other components. The AI agent workflows 116 may include agents built in LangChain that interact with tools developed in LlamaIndex, and/or may consist of single-framework implementations that still benefit from the cross-framework analysis capabilities provided by the system.

A profiler component 112 may perform offline inference performance analysis of the agent workflows by collecting and analyzing execution traces from workflow runs. This profiler may simulate multiple concurrent users interacting with agent workflows to identify performance bottlenecks that only manifest under concurrent load conditions. The profiler component 112 may generate latency analysis reports, conduct bottleneck analysis at the function level, and may identify token efficiency patterns across different stages of agent workflow execution. The profiler component 112 can generate function descriptions of the AI agent workflows 116 for an execution plan generation system 106 to use in generating the execution plans for the AI agent workflows 116.

The execution plan generation system 106 coordinates the creation of structured execution plans that break down user requests into specific actionable steps for AI agent workflows. This execution plan generation system 106 works with one or more machine learning models (e.g., LMs) to analyze user requests in context of available tools and agent objectives, generating detailed execution sequences that specify which tools or functions should be called at each step along with required input parameters. In some embodiments, the machine learning models include one or more reasoning models. The execution plan generation system 106 enables separation of reasoning operations from instruction-following operations by providing instruction-following models, such as AI agent workflows 116, with comprehensive roadmaps for efficient workflow execution.

During operation, the dynamic function inspection capabilities of the AI agent system 104 automatically discover and register functions with input schemas, output schemas, descriptions, and entry points across all supported frameworks. When developers define functions within agent workflows, the system collects function registration data at build time to enable comprehensive understanding of available workflow components. This function registration process occurs transparently without requiring modifications to underlying agent implementations, providing the AI agent system 104 with complete information about tools, agents, and functions that workflows can utilize.

For example, the execution plan generation system 106 coordinates the creation of structured execution plans that break down user requests into specific actionable steps for AI agent workflows through multiple mechanisms that accommodate both explicit developer input and/or automated discovery processes. In scenarios where developers explicitly provide function descriptions, the execution plan generation system 106 leverages comprehensive metadata including input schemas, output schemas, descriptions, and entry points that developers define when registering functions with the AI agent system's builder registry. For example, a developer might register a customer service function with explicit descriptions such as “retrieves customer ticket information from JIRA database” along with detailed input schemas specifying required parameters like ticket_id (string) and priority_level (integer), enabling the reasoning model to generate precise execution plans that specify exactly how this function should be called within a larger workflow sequence.

When function descriptions are not explicitly provided by developers or when comprehensive metadata is incomplete, the execution plan generation system 106 employs advanced automatic discovery capabilities that analyze source code at build time to infer framework usage and function purposes. The execution plan generation system 106 inspects code structure, library imports, function signatures, and dependency declarations to automatically discover language model frameworks used in function definitions, such as identifying LangChain callback mechanisms, LlamaIndex service context patterns, and/or CrewAI agent instantiation methods without requiring explicit developer declarations. This automated introspection process enables the execution plan generation system 106 to generate standardized function descriptions even when developers fail to provide adequate documentation, ensuring that the reasoning model receives sufficient contextual information to create effective execution plans regardless of the completeness of manual documentation.

The reasoning prompt generation process represents a component of the execution plan generation system 106, involving contextual framing that combines user requests with comprehensive agent objectives and available resource inventories of the AI agent workflows 116. The execution plan generation system 106 collects high-level descriptions of AI agent workflows to generate agent objectives, analyzes available resources including tools and functions accessible through function registration data of the AI agent workflows 116, and constructs reasoning prompts that frame user requests within the context of these objectives and resources. For instance, when processing a request like “analyze our team's progress on the Acme Corp project,” the execution plan generation system 106 generates a prompt that includes the user's query, the agent's objective (such as “project management and progress tracking”), and detailed descriptions of available tools including JIRA integration functions, resource allocation tools, and reporting capabilities, enabling the reasoning model to create a comprehensive execution plan that might specify steps like “first retrieve JIRA tickets for Acme Corp, then analyze completion rates, finally generate progress summary.”

The execution plan generation system 106 demonstrates particular sophistication in its ability to automatically detect input and output data types of workflow functions and perform seamless type conversions between reasoning model outputs and downstream workflow function inputs. When a reasoning model generates an execution plan that specifies calling a database query function with parameters formatted as natural language descriptions, the execution plan generation system 106 automatically converts these into the structured data types required by the target function, such as transforming “retrieve tickets with high priority” into properly formatted API calls with specific parameter values like {“priority”: “high”, “status”: “open” }. This automatic type handling ensures compatibility across different framework implementations while maintaining the separation between planning operations performed by reasoning models and execution operations performed by instruction-following models.

The workflow-agnostic capabilities of the execution plan generation system 106 enable execution plan generation across heterogeneous agent implementations, allowing developers to wrap any function within their agent workflows with reasoning capabilities through simple configuration specifications. Whether dealing with individual functions, complete agent workflows, or specific components within complex multi-framework implementations, the execution plan generation system 106 can selectively apply reasoning at multiple levels of workflow hierarchy based on developer-specified configuration parameters. For example, a developer might configure the system to apply reasoning wrappers only to high-level decision-making functions while leaving routine data processing tasks unwrapped, or alternatively wrap tool interactions with planning capabilities to improve accuracy in complex scenarios involving multiple external API integrations.

In some embodiments, advanced extensions of the execution plan generation system 106 incorporate behavioral profiling and continuous learning mechanisms that enhance plan generation accuracy over time through analysis of execution patterns and failure scenarios. The execution plan generation system 106 can build behavioral profiles of AI agent workflows through continuous monitoring, analyzing historical performance data to identify common failure scenarios and bottlenecks, then incorporating these behavioral insights into prompt construction for reasoning models to generate more robust execution plans. Additionally, the execution plan generation system 106 supports validation mechanisms that can implement logical consistency checking before execution begins, analyzing generated plans for non-sequitur elements or logical errors and routing invalid portions back to reasoning models for refinement, creating a self-improving cycle that enhances plan quality through iterative feedback and optimization.

The execution plan generation capabilities can be further enhanced to include conditional logic and branching instructions that enable dynamic adaptation during workflow execution. When the reasoning model generates an execution plan, the reasoning model can incorporate conditional statements that specify alternative instruction sequences based on expected outcomes, error conditions, and/or performance criteria not being met. For example, if a primary tool call fails to return expected results or produces an error, the execution plan can include predefined alternative approaches such as “if the JIRA query returns no results, then attempt the search with broader parameters” or “if the database connection fails, switch to the backup data source and retry the operation.” These conditional execution paths enable the instruction-following models (e.g., AI agent workflows 116) to handle unexpected scenarios without requiring additional reasoning during execution, maintaining the separation between planning and execution while providing robust error handling and adaptive behavior. The reasoning model can analyze historical failure patterns and common edge cases during plan generation to proactively include appropriate conditional branches, creating execution plans that are resilient to typical workflow disruptions and can automatically adjust their approach based on real-time execution results.

FIG. 1 further shows a language model 118 and memory 122. The language model 118 may represent language model integrations that are monitored and analyzed by the AI agent system 104. The system may track LM inference requests, measure response times, and may analyze token utilization patterns for prompt tokens versus completion tokens. The language model 118 analysis may help developers understand the efficiency of their language model usage and may identify opportunities for prompt reduction or caching. The language model 118 may be incorporated at least in part into the reasoning model of the execution plan generation system 106.

The memory 122 component may represent conversation history and context management operations that support the separation of planning and execution phases in AI agent workflows. The AI agent system 104 may utilize memory 122 to store execution plans generated by reasoning models, maintain conversation context across planning and execution phases, and preserve the contextual information needed for dynamic function introspection and type conversion operations. The memory 122 component enables the reasoning wrapper functionality by storing comprehensive function registration data, agent objectives, and tool descriptions that are collected during build time inspection and used for generating contextual execution plans. This memory management supports the workflow-agnostic abstractions by maintaining the state information required for automatic type conversions between reasoning model outputs and downstream workflow function inputs, ensuring seamless integration across different AI agent frameworks. The memory 122 analysis may help developers understand how context preservation and execution plan storage impact the effectiveness of the reasoning wrapper deployment across different agent implementations and configuration scenarios.

A retriever component 120 may represent retrieval operations and tools that can be dynamically inspected by the AI agent system 104 for inclusion in reasoning-generated execution plans. The AI agent system 104 may automatically discover retriever functions through function registration data, collecting their input schemas, output schemas, descriptions, and entry points to enable comprehensive understanding of available retrieval capabilities.

When reasoning models generate execution plans, the retriever component 120 may be specified as part of structured execution sequences, with the reasoning model determining when retrieval operations should be performed, what parameters should be used, and how retrieval results should be processed by instruction-following models. The retriever component 120 benefits from the automatic type conversion capabilities that enable seamless integration between reasoning model outputs specifying retrieval parameters and the actual input data types required by retrieval functions, ensuring compatibility across different framework implementations. The retriever component 120 may also be selectively wrapped with reasoning capabilities, allowing developers to apply planning logic specifically to retrieval operations when complex retrieval strategies are needed, while maintaining the separation between reasoning operations that determine retrieval strategy and instruction-following operations that execute the actual retrieval calls.

In some examples, the extracted metadata from all components may be normalized across different frameworks into a unified data model that gets published to an intermediate step stream. This normalization process may be enabled by the AI agent system's approach of wrapping individual functions with standardized input schemas, output schemas, and descriptions, regardless of whether those functions represent agents, tools, LLMs, or other workflow components. By wrapping each function in this standardized interface, the toolkit may create a common abstraction layer that allows framework-specific data structures to be converted into the unified data model. This function wrapping mechanism may ensure that LLM events, tool events, and other workflow events appear identical regardless of their originating framework, since all wrapped functions conform to the same standardized format with defined inputs, outputs, and descriptions. The standardized intermediate step stream may enable consistent analysis capabilities across heterogeneous agent implementations because the wrapped functions provide a framework-agnostic foundation for data collection and normalization.

For example, the extracted metadata normalization process operates by taking framework-specific data structures and converting them into a standardized intermediate representation that maintains semantic consistency across all supported agent frameworks. Namely, when a LangChain agent makes an LLM call, the callback handler extracts metadata that might include LangChain-specific fields such as: langchain.schema.messages.AIMessage; objects with nested content; and additional_kwargs fields, alongside timing data in LangChain's proprietary format. Simultaneously, when a LlamaIndex agent performs a similar LLM operation, its callback handler captures metadata in LlamaIndex's native format, which could include: llama_index.core.base.llms.types.ChatMessage objects with different field structures and timestamp representations. The normalization engine then transforms both of these disparate data structures into a unified format that includes standardized fields such as: input_text, output text, prompt tokens, completion tokens, latency_ms, timestamp_iso, and function_ancestry, ensuring that an LLM call appears identical regardless of whether it originated from LangChain, LlamaIndex, CrewAI, or any other supported framework.

The intermediate step stream serves as the central nervous system for this standardized data flow, implementing a reactive publisher-subscriber architecture that maintains event ordering and hierarchy relationships across framework boundaries. When normalized metadata events are published to the stream, they can include enriched contextual information such as parent-child function relationships, execution depth levels, and cross-framework correlation identifiers that enable comprehensive workflow analysis. For instance, if an agent workflow begins with a LangChain ReAct agent that calls a LlamaIndex retriever tool, which subsequently invokes a CrewAI sub-agent, the intermediate step stream maintains a complete ancestry chain showing how langchain_react_agent.execute( ) called llamaindex_retriever.search( ) which then called crewai_specialist.analyze( ). Each event in the stream contains standardized metadata fields including execution timestamps (e.g., start_time: 2025-01-15T14:30:25.123Z), token utilization metrics (e.g., prompt_tokens: 1247, completion_tokens: 389), and performance indicators (e.g., execution_duration_ms: 2340), enabling downstream subscribers to perform consistent analysis regardless of the underlying framework complexity.

This standardization process enables powerful cross-framework reasoning wrapper capabilities where execution plan generation components, function registration systems, and reasoning model integrators can all consume the same unified function description data without requiring framework-specific parsing logic. The stream supports multiple concurrent reasoning operations that can filter and process function metadata based on standardized criteria, such as identifying all available tools and their input/output schemas for execution plan generation, or tracking workflow component dependencies that span more than three different frameworks during dynamic introspection. Additionally, the intermediate function registration system maintains hierarchical relationships and supports dynamic type conversion capabilities, allowing reasoning wrapper algorithms to reconstruct complete workflow composition understanding and enable automatic type handling at any level of the agent architecture, whether they occur within individual framework boundaries or at framework integration points where execution plans must be marshaled between reasoning models and instruction-following agent implementations.

The automatic type conversion capabilities enable seamless integration between reasoning model outputs and downstream workflow function inputs through dynamic inspection of function signatures and data types. The AI agent system 104 automatically detects input and output data types of workflow functions and performs necessary type conversions when reasoning models generate execution plans that must be passed to instruction-following components. This type conversion process ensures compatibility across different framework implementations while maintaining the separation between planning operations performed by reasoning models and execution operations performed by instruction-following models

A telemetry component 124 may collect and manage performance metrics generated during workflow analysis. This telemetry component 124 may gather timing data, resource utilization statistics, and workflow execution traces that enable comprehensive performance characterization. The telemetry component 124 may support multiple subscriber types that can access the telemetry data for different purposes including profiling, evaluation, and observability. The telemetry component 124 can be used by the profiler component 112 to generate function descriptions and behavior information about the AI agent workflows 116 to feed back to the execution plan generation system 106 to generated updated execution plans.

An observability platform 126 component may receive exported trace data in OpenTelemetry-compatible formats for visualization and monitoring purposes. The AI agent system 104 may convert intermediate steps into framework-specific visualization formats that work with different observability tools. This capability may enable cross-framework observability where agents built in one framework can be visualized using tools associated with different frameworks.

The results generated by the AI agent system 104 may be output in standardized formats that enable developers to identify workflow performance characteristics and behavioral insights. These outputs may include performance efficiency metrics, bottleneck analysis reports, and token utilization patterns that help developers make informed decisions about agent workflow deployment and resource allocation. The standardized output format may ensure compatibility with various development tools and may facilitate integration with existing development workflows.

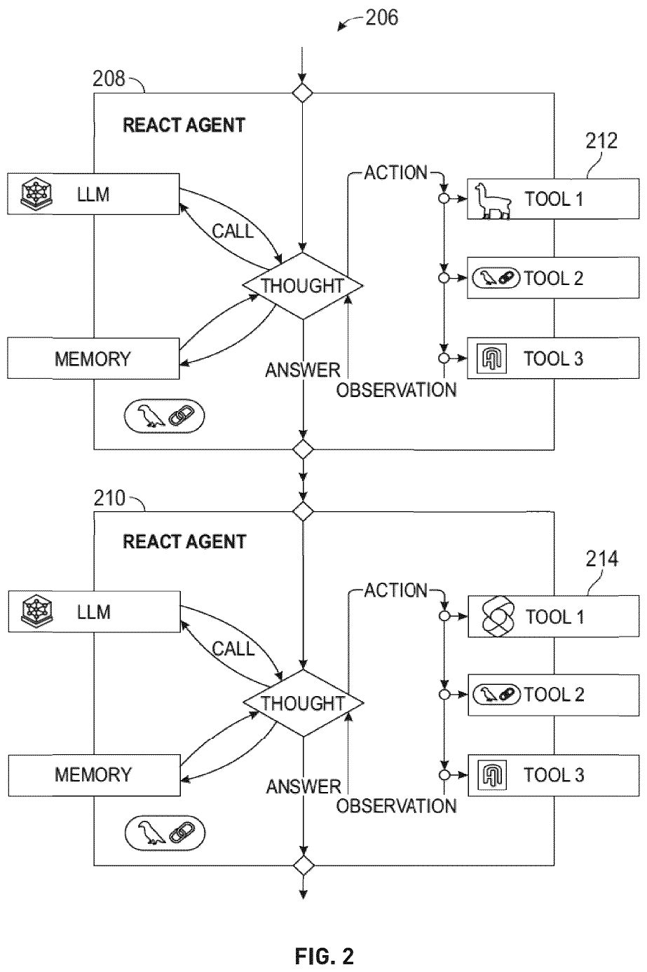

FIG. 2 illustrates the reasoning wrapper capabilities of the AI agent system 104, according to at least some embodiments of the present disclosure, demonstrating how multiple AI agent workflows created using different frameworks can be seamlessly enhanced with planning capabilities through automated reasoning wrapper deployment using the execution plan generation system 106. The AI agent workflow diagram 206 shows two distinct ReAct agent implementations that can be wrapped by the execution plan generation system 106 with reasoning models to separate planning operations from execution operations, enabling improved performance through execution plan generation while maintaining compatibility with existing agent development frameworks.

A first AI agent workflow 208 represents a ReAct agent implementation that can be enhanced through reasoning wrapper deployment to separate planning from execution operations. This first AI agent workflow 208 can receive reasoning-generated execution plans that provide structured sequences of actionable steps, enabling the LLM component to follow detailed instructions rather than performing complex reasoning during execution. The reasoning wrapper approach allows the first AI agent workflow 208 to benefit from planning capabilities without requiring modifications to its underlying ReAct implementation or tool integration patterns.

A first set of tools 212 associated with the first AI agent workflow 208 includes Tool 1, Tool 2, and Tool 3, each of which can be dynamically inspected by the execution plan generation system 106 for reasoning wrapper deployment. The execution plan generation system 106 automatically collects input schemas, output schemas, descriptions, and entry points from these tools to enable comprehensive understanding of available workflow capabilities. When reasoning wrappers are applied, the execution plan generation system 106 constructs prompts for reasoning models that include detailed descriptions of these tools, enabling the generation of execution plans that specify which tools should be called at each step along with required input parameters and expected outputs.

A second AI agent workflow 210 demonstrates the system's ability to apply reasoning wrapper functionality across different agent implementations that may utilize entirely different frameworks from the first workflow. This second ReAct agent can be independently wrapped with reasoning capabilities, illustrating how the AI agent system 104 enables workflow-agnostic reasoning integration regardless of underlying framework implementations. The reasoning wrapper deployment process automatically inspects the second AI agent workflow 210 to collect tool descriptions and agent objectives, then generates contextual execution plans that frame user requests within the workflow's specific capabilities and objectives, enabling efficient separation of planning operations from instruction-following operations.

The automatic type conversion capabilities enable seamless integration between reasoning model outputs and the input requirements of both agent workflows. When reasoning models generate execution plans containing tool invocation specifications, the AI agent system 104 automatically performs type conversions to ensure compatibility between plan parameters and the actual data types required by workflow functions. This type handling occurs transparently across both the first AI agent workflow 208 and second AI agent workflow 210, regardless of their framework implementations or tool configurations.”

The configuration-driven reasoning wrapper deployment allows developers to enhance either or both agent workflows with planning capabilities through simple configuration file specifications. Users can selectively apply reasoning wrappers at multiple levels of workflow hierarchy, such as wrapping entire agents, individual tools, or specific workflow components based on configuration parameters. This configurability enables flexible deployment scenarios where reasoning capabilities can be applied precisely where needed without requiring code modifications to existing agent implementations.

The execution plan generation process for both workflows involves collecting high-level workflow descriptions to understand agent objectives, analyzing available tools and functions through dynamic function registration data, and constructing reasoning prompts that frame user requests within the context of workflow capabilities. The generated execution plans provide structured roadmaps that enable instruction-following models to execute workflow operations efficiently while maintaining the separation between reasoning operations performed by planning models and execution operations performed by the underlying ReAct agents.

The AI agent workflow diagram 206 illustrates how the AI agent system's reasoning wrapper abstractions enable complex multi-agent scenarios where different agents built using different frameworks can be enhanced with planning capabilities as part of a unified system. This capability allows developers to leverage the efficiency gains from model separation, such as using reasoning models for planning and instruction-following models for execution, while maintaining comprehensive configurability and cross-framework compatibility across their entire agent ecosystem.

For example, when the first AI agent workflow 208 receives a user request such as “Help me analyze our Q4 sales performance and identify areas for improvement,” the reasoning model generates a targeted execution plan that leverages only specific tools based on the query complexity and requirements. The execution plan might specify: “Step 1: Use Tool 1 (sales data retriever) to fetch Q4 sales metrics from the CRM system with parameters {time period: ‘Q4_2024’, metrics: [‘revenue’, ‘conversion_rates’, ‘customer_acquisition’]}. Step 2: Use Tool 3 (analytics processor) to perform comparative analysis against Q3 performance with input parameters from Step 1 results. Step 3: Generate summary insights and recommendations based on the processed analytics data.” In this scenario, the reasoning model intelligently excludes Tool 2 from the execution plan because it determines through dynamic function introspection that Tool 2 handles inventory management functions that are not relevant to the sales analysis request, demonstrating the system's ability to generate selective, context-aware execution plans that optimize efficiency by utilizing only the necessary workflow components.

For the second AI agent workflow 210 that includes a second set of tools 214, when processing a comprehensive request like “Conduct a complete audit of our customer service operations including ticket analysis, agent performance review, and system integration status,” the reasoning model generates an exhaustive execution plan that coordinates all available tools (e.g., second set of tools 214) in a systematic sequence. The execution plan encompasses: “Step 1: Use Tool 1 (ticket data extractor) to retrieve all customer service tickets from the past month with parameters {status: ‘all’, date_range: ‘last_30_days’, include_metadata: true}. Step 2: Use Tool 2 (performance analyzer) to evaluate agent response times and resolution rates using ticket data from Step 1. Step 3: Use Tool 3 (system integration checker) to verify connectivity and data flow between customer service platforms and external systems. Step 4: Compile comprehensive audit report combining insights from all previous steps with cross-referenced data validation.” This comprehensive execution plan demonstrates the system's capability to orchestrate complex multi-tool workflows where each tool's output serves as contextual input for subsequent operations, enabling the instruction-following model to execute sophisticated business processes with full workflow coordination while maintaining the separation between reasoning operations and execution operations.

In some cases, this selective tool utilization demonstrates a benefit of the reasoning wrapper approach, where the execution plan generation system 106 intelligently determines which tools are necessary for a given request rather than executing all available tools indiscriminately. In the first workflow example, the reasoning model's execution plan strategically excludes Tool 2, for example, because the developer specifically configured the reasoning wrapper to focus on sales analysis capabilities, and the dynamic function introspection revealed that Tool 2's inventory management functions were not relevant to the user's Q4 sales performance request. This intelligent tool selection occurs because the reasoning model analyzes both the user request context and the comprehensive function descriptions collected during build time, enabling it to generate execution plans that utilize only the tools whose capabilities align with the specific task requirements. The configuration-driven nature of the reasoning wrapper allows developers to specify which tool categories or functions should be prioritized for different types of requests, ensuring that execution plans are both efficient and contextually appropriate while maintaining the separation between reasoning operations that determine tool selection and instruction-following operations that execute the selected tools.

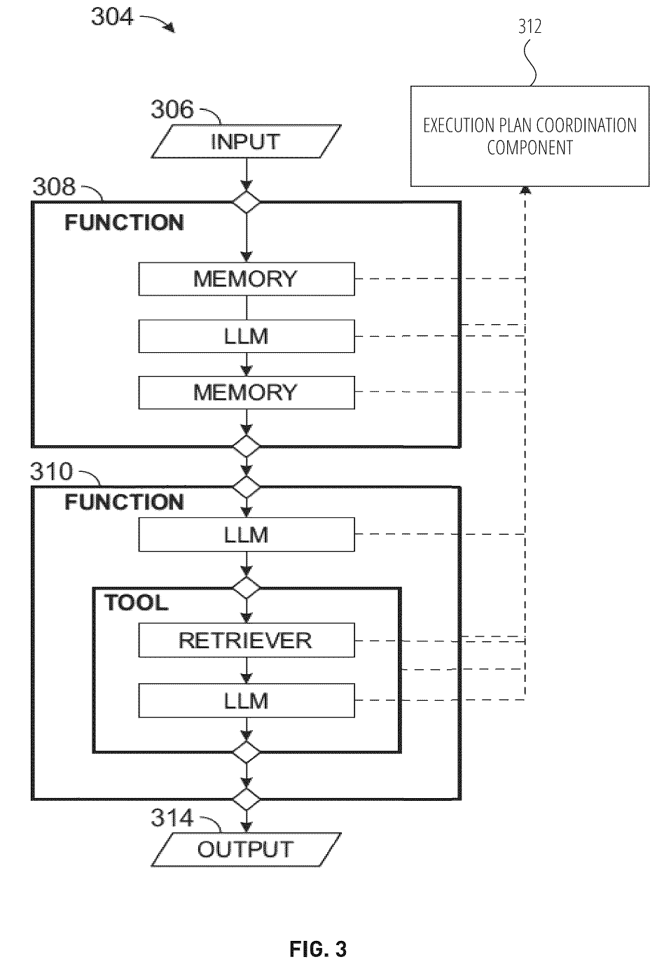

FIG. 3 illustrates a task-agnostic reasoning wrapper system 304, according to at least some embodiments of the present disclosure. Specifically, FIG. 3 illustrates the task-agnostic reasoning wrapper system 304 that demonstrates how the AI agent system 104 enables dynamic function introspection and execution plan generation for AI agent workflows regardless of their underlying framework implementations. This task-agnostic reasoning wrapper system 304 represents the core functionality that enables developers to wrap any workflow with reasoning capabilities through configuration-driven deployment, showing the flow of data from initial input 306 through reasoning model analysis and execution plan generation to final output 314, while maintaining framework-agnostic abstractions for workflow composition understanding.

An input 306 represents the starting point where user requests enter the task-agnostic reasoning wrapper system 304 for processing by AI agent workflows enhanced with planning capabilities. This input 306 may contain various types of user queries that require reasoning model analysis to generate structured execution plans, similar to how the API server 114 described in FIG. 1 receives requests from developers seeking to wrap their agent workflows with reasoning capabilities. The input 306 feeds into the dynamic function introspection pipeline that enables framework-agnostic analysis and execution plan generation across different agent implementations.

A first AI agent workflow 308 (e.g., first function implementation) demonstrates how the task-agnostic reasoning wrapper system 304 can analyze and enhance agent implementations that include memory components and language model 118 integration. This first AI agent workflow 308 represents how agents built in frameworks such as LangChain or LlamaIndex can be dynamically inspected by the reasoning wrapper system to collect input schemas, output schemas, descriptions, and entry points for comprehensive workflow understanding. The reasoning wrapper approach allows the system to generate contextual execution plans for this workflow regardless of its specific framework implementation, enabling separation of reasoning operations from instruction-following operations.

A second AI agent workflow 310 illustrates an alternative agent architecture that incorporates language model 118 capabilities, tool integrations, retriever component 120 functionality, and additional processing stages that can be enhanced through reasoning wrapper deployment. This second AI agent workflow 310 demonstrates the flexibility of the reasoning wrapper system to handle diverse agent implementations, including those that utilize retrieval-augmented generation patterns through the retriever component 120, multi-step reasoning processes, and complex tool interaction sequences. The reasoning wrapper system can automatically inspect these varied architectures to generate execution plans that specify which tools should be called at each step along with required input parameters and expected outputs.

The first AI agent workflow 308 and second AI agent workflow 310 may be built using different underlying frameworks to demonstrate the system's framework-agnostic capabilities. For example, the first AI agent workflow 308 might be implemented using LangChain while the second AI agent workflow 310 could be built using LlamaIndex or CrewAI. The architectural differences between these workflows illustrate the diversity of agent implementations that the AI agent system can support. The second AI agent workflow 310 includes both retriever component 120 functionality and multiple language model 118 processing stages because it may implement a retrieval-augmented generation pattern where the second AI agent workflow 310 needs to search external knowledge bases or vector databases to enhance its responses with contextual information. In contrast, the first AI agent workflow 308 focuses on memory-based processing without external retrieval, representing a simpler conversational agent that relies primarily on conversation history and context management through its memory components. This diversity in architectural patterns demonstrates how the task-agnostic reasoning wrapper system 304 can standardize and analyze performance across different agent implementations regardless of whether they utilize retrieval operations, multiple reasoning steps, or varying combinations of tools and frameworks.

The dynamic function introspection capabilities enable the task-agnostic reasoning wrapper system 304 to analyze both implementations regardless of their architectural differences or framework origins. The task-agnostic reasoning wrapper system 304 collects comprehensive metadata about available tools, agents, and functions through build-time registration data, then constructs reasoning prompts that frame user requests within context of agent objectives and available resources. When reasoning models generate execution plans based on this introspection data, the task-agnostic reasoning wrapper system 304 (e.g., the execution plan generation system 106) automatically performs type conversions between reasoning model outputs and downstream workflow function inputs, ensuring seamless integration across different framework implementations while maintaining the separation between planning operations and execution operations.

The coordination between the first AI agent workflow 308 and second AI agent workflow 310 through the task-agnostic reasoning wrapper system 304 demonstrates how execution plan generation can be applied selectively across different workflow components based on developer configuration. This interconnection enables the task-agnostic reasoning wrapper system 304 to provide configuration options for applying reasoning at multiple levels of workflow hierarchy, allowing developers to wrap entire agents, individual tools, or specific workflow components with planning capabilities. The task-agnostic reasoning wrapper system 304 maintains comprehensive understanding of workflow composition and tool dependencies that enables intelligent execution plan generation regardless of whether workflows span multiple frameworks or utilize different implementation approaches.

An execution plan coordination component 312 plays a central role in the task-agnostic reasoning wrapper system 304 by generating structured execution plans that break down user requests into specific actionable steps for AI agent workflows. This execution plan coordination component 312 implements the reasoning model integration that analyzes user requests in context of dynamically discovered workflow capabilities and agent objectives, generating detailed execution sequences that specify which tools or functions should be called at each step along with corresponding input parameters. The execution plan coordination ensures that instruction-following models receive comprehensive roadmaps for efficient workflow execution while maintaining the framework-agnostic abstractions that distinguish this system from manual reasoning integration approaches.

The data flow from both function implementations toward the execution plan coordination component 312 demonstrates how the task-agnostic reasoning wrapper system 304 enables seamless handoff between planning operations performed by reasoning models and execution operations performed by instruction-following models. The execution plan coordination component 312 receives comprehensive workflow understanding from dynamic function introspection, generates contextual execution plans using reasoning models, and passes these plans along with user requests to target workflow functions for processing. This dual-phase approach ensures that agent workflows can benefit from enhanced planning capabilities while maintaining compatibility with existing agent implementations through standardized wrapper mechanisms and automatic type conversion capabilities.

An output 314 represents the final stage where processed results from the enhanced agent workflows are delivered to users, demonstrating the successful execution of reasoning-generated plans by instruction-following models. This output 314 stage shows how the task-agnostic reasoning wrapper system 304 enables improved performance on complex queries through the separation of planning and execution operations while maintaining transparency in workflow operation. The reasoning wrapper approach ensures that agent workflows can leverage the efficiency gains from model separation, such as using reasoning models for planning and instruction-following models for execution, without requiring modifications to existing agent implementations.

The configuration-driven reasoning wrapper deployment shown through the execution plan coordination component 312 enables the task-agnostic planning capabilities where AI agent workflows 116 can be enhanced with reasoning functionality through simple configuration file specifications rather than manual programming. This standardization process ensures that reasoning wrapper functionality appears consistent regardless of underlying framework implementations, supporting the unified planning and execution capabilities that distinguish this system from framework-specific solutions. Developers can selectively apply reasoning wrappers at multiple levels of workflow hierarchy based on configuration parameters, enabling flexible deployment scenarios where planning capabilities can be applied precisely where needed.

The task-agnostic reasoning wrapper system 304 shown in FIG. 3 provides the dynamic function introspection and execution plan generation capabilities that enable the task-agnostic planning functionality implemented by the AI agent system 104, including automatic workflow composition analysis for reasoning prompt construction, contextual execution plan generation using configurable reasoning models, automatic type conversion between reasoning model outputs and workflow function inputs, and configuration-driven reasoning wrapper deployment that enables developers to enhance any arbitrary workflow with planning capabilities through transparent and workflow-agnostic integration mechanisms.

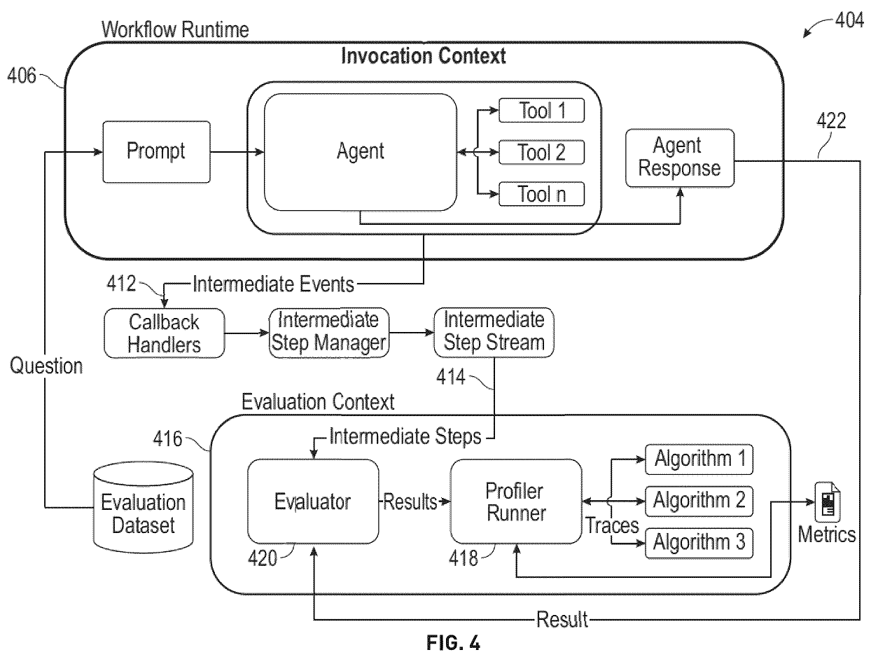

FIG. 4 illustrates a reasoning wrapper evaluation system 404, according to at least some embodiments of the present disclosure. Specifically, FIG. 4 illustrates the reasoning wrapper evaluation system 404 that demonstrates the comprehensive reasoning wrapper deployment and execution plan validation capabilities of the AI agent system 104 for enhancing AI agent workflows during execution. This reasoning wrapper evaluation system 404 represents the integration of dynamic function introspection, execution plan generation, and reasoning model coordination that enables developers to obtain detailed planning insights and execution validation from their agent implementations. The reasoning wrapper evaluation system 404 provides a unified framework for collecting workflow composition data, generating execution plans, and validating reasoning wrapper functionality across AI agent workflows 116 regardless of their underlying framework implementations.

The workflow runtime component serves as the execution environment where AI agent workflows 406 enhanced with reasoning wrappers operate and process user requests through generated execution plans. This runtime environment coordinates the execution of reasoning-generated plans across various workflow components including agents, tools, and other processing elements while maintaining comprehensive reasoning wrapper instrumentation capabilities. The workflow runtime ensures that all execution plan implementation events are properly captured and made available for reasoning wrapper validation and optimization analysis. The invocation context within the workflow runtime component represents the execution environment and state information that surrounds each reasoning-wrapped workflow execution instance, including session data, user information, reasoning model configuration parameters, and execution plan specifications that influence how the AI agent workflow 406 processes requests according to reasoning-generated execution plans.

The AI agent workflow 406 represents the target system being enhanced with reasoning wrapper capabilities, which can include any combination of agents, tools, language models, retrievers, and other components implemented across different frameworks that can be wrapped with execution plan generation functionality. This workflow executes the core business logic and processing required to handle user queries according to reasoning-generated execution plans while maintaining separation between planning operations and instruction-following operations. The AI agent workflow 406 is enhanced through the reasoning wrapper evaluation system 404 to provide execution plan validation and reasoning wrapper performance analysis without requiring modifications to the underlying workflow implementation.

The evaluation dataset provides reference workflows and test scenarios that are used to systematically evaluate reasoning wrapper deployment effectiveness and execution plan generation quality for the AI agent workflow 406. This evaluation dataset includes representative workflow configurations, expected execution plan structures, and reasoning wrapper validation criteria that enable consistent and repeatable analysis of reasoning wrapper implementations across different agent architectures. The evaluation dataset supports both automated reasoning wrapper testing processes and manual validation workflows for execution plan generation accuracy.

Evaluation context 416 contains specific reasoning wrapper deployment parameters such as reasoning model selection criteria (e.g., ‘use reasoning model A for complex multi-tool workflows’), execution plan validation thresholds (e.g., ‘flag plans with more than 8 sequential steps for human review’), and type conversion accuracy benchmarks (e.g., ‘ensure automatic type conversions maintain data integrity above 99.5%’). The context also specifies reasoning wrapper analysis parameters including which validation algorithms to apply, such as enabling logical consistency checking for execution plans with conditional branching, or activating tool dependency analysis for workflows that include cross-framework function calls across more than three different agent implementations.

The evaluation context 416 also includes workflow-specific reasoning wrapper configuration parameters that customize the execution plan generation approach based on the type of agent being enhanced. For instance, the evaluation context 416 may specify that customer service workflows should prioritize execution plans with clear fallback strategies, while data analysis workflows should emphasize execution plans that may improve tool utilization efficiency. The context defines custom reasoning model configurations appropriate for different workflow types, establishes baseline execution plan quality metrics derived from previous reasoning wrapper deployments, and configures the scope and frequency of reasoning wrapper validation processes.

Intermediate steps 414, generated by intermediate events 412, represent the processed and standardized execution plan data and reasoning wrapper coordination information that has been prepared for validation analysis. These intermediate steps 414 include normalized representations of execution plan structures, reasoning model invocations, type conversion operations, and workflow coordination events generated during reasoning wrapper deployment. The intermediate steps 414 maintain temporal ordering and hierarchical relationships that enable comprehensive reasoning wrapper effectiveness analysis.

An evaluator component 420 implements the reasoning wrapper validation logic that assesses execution plan quality, reasoning wrapper deployment effectiveness, and planning-execution separation performance. This evaluator component 420 applies various validation metrics and algorithms to the collected reasoning wrapper data to generate quantitative assessments of execution plan generation and reasoning wrapper deployment success. The evaluator component 420 supports multiple validation methodologies and can be configured to assess different aspects of reasoning wrapper performance including plan coherence, tool selection accuracy, and type conversion reliability.

The evaluator component 420 implements reasoning wrapper validation logic that operates on the standardized intermediate steps 414 and evaluation context 416 to generate comprehensive assessments of execution plan quality and reasoning wrapper deployment effectiveness across multiple dimensions. This evaluator component 420 applies diverse validation methodologies including execution plan coherence metrics that analyze logical consistency and step sequencing, as well as reasoning wrapper performance metrics that evaluate the effectiveness of planning-execution separation and automatic type conversion capabilities.

A profiler component 418 implements specialized reasoning wrapper analysis algorithms that focus on execution plan generation characteristics, reasoning model integration patterns, and configuration deployment effectiveness. This profiler component 418 analyzes reasoning wrapper execution traces to identify planning efficiency improvements, execution plan validation bottlenecks, and type conversion optimization opportunities. The profiler component 418 generates detailed reasoning wrapper performance reports including execution plan quality metrics that help developers understand and optimize their reasoning wrapper implementations across different agent architectures.

A results 422 component consolidates and presents the outcomes of the reasoning wrapper evaluation and execution plan validation analysis in formats suitable for developer consumption. These results include reasoning wrapper deployment reports, execution plan quality insights, configuration optimization recommendations, and comparative analysis across different reasoning wrapper configurations or agent implementations. The results 422 are formatted to support both automated reasoning wrapper optimization and human interpretation of execution plan generation effectiveness.

The reasoning wrapper evaluation system 404 coordinates the interaction between all these components to provide a comprehensive reasoning wrapper analysis framework that operates transparently during execution plan generation and validation. The system automatically discovers agent workflow implementations, registers appropriate reasoning wrapper instrumentation, collects and normalizes execution plan data, applies validation algorithms, and generates actionable insights that help developers understand and optimize their reasoning wrapper deployments across different framework implementations and agent workflow deployment scenarios.

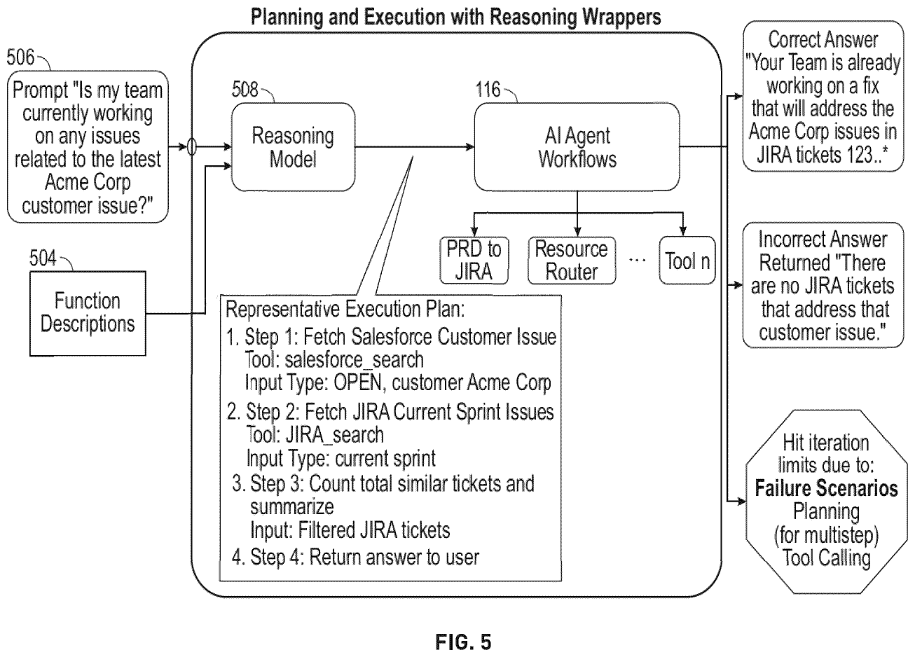

FIG. 5 illustrates a reasoning model system (e.g., execution plan generation system 106), according to at least some embodiments of the present disclosure. Specifically, FIG. 5 illustrates the planning and execution process with reasoning wrappers that enables developers to enhance any of the AI agent workflows 116 with planning capabilities through automated execution plan generation. The execution plan generation system 106 demonstrates how function descriptions 504, user requests 506, reasoning model 508, and AI agent workflows 116 work together to separate planning operations from execution operations, allowing for improved performance on complex queries while maintaining framework-agnostic functionality across different agent implementations.

The function descriptions 504 represent the comprehensive metadata that the execution plan generation system 106 collects about available tools, agents, and/or workflow components through dynamic function introspection and/or manual input by the developer. These function descriptions may include input schemas, output schemas, detailed descriptions, and/or entry points for each registered function within the AI agent workflows 116. For example, when a developer registers a customer service function, the function descriptions 504 may contain entries such as “retrieves customer ticket information from JIRA database” along with input schema specifications like ticket_id (string) and priority_level (integer), enabling the reasoning model 508 to understand how this function can be utilized within execution plans.

The user request 506 represents the initial query or task that enters the system and triggers the reasoning wrapper functionality. This user request 506 may contain various types of queries that require complex reasoning and multi-step execution, such as “Help me analyze our Q4 sales performance and identify areas for improvement” or “Conduct a complete audit of our customer service operations including ticket analysis and agent performance review.” The execution plan generation system 106 processes these user requests 506 by combining them with comprehensive workflow understanding to generate contextual execution plans that frame the request within the specific capabilities and objectives of the target AI agent workflows 116.

The reasoning model 508 serves as the central planning component that analyzes user requests 506 in the context of available function descriptions 504 to generate structured execution plans for the AI agent workflows 116. This reasoning model 508 may utilize large language models that excel at complex planning, iterative decomposition, and breaking down bigger problems into series of actionable steps. The reasoning model 508 receives specially constructed prompts that include the user request, agent objectives derived from workflow descriptions, and comprehensive information about available tools and functions, enabling it to create detailed execution plans that specify which tools should be called at each step along with required input parameters and expected outputs.

For example, the reasoning model 508 demonstrates sophisticated prompt construction capabilities that accommodate both explicit developer-provided function descriptions and automatically derived metadata through dynamic introspection. In scenarios where developers explicitly register functions with comprehensive metadata, the reasoning model 508 receives rich contextual information to generate precise execution plans. For example, when a developer registers a customer service function with explicit descriptions such as “retrieves customer ticket information from JIRA database” along with detailed input schemas specifying required parameters like ticket\_id (string) and priority\_level (integer), the reasoning model can generate highly targeted execution plans. A typical prompt in this scenario might include: “Given the user request ‘Help me analyze our Q4 sales performance,’ the agent's objective of ‘project management and progress tracking,’ and available tools including: (1) JIRA integration function with inputs {ticket\_id: string, priority\_level: integer} that retrieves customer tickets, (2) analytics processor with inputs {data\_source: object, comparison\_period: string} that performs comparative analysis, please generate a structured execution plan that accomplishes the user's request using available resources.”

When function descriptions are incomplete or absent, the reasoning model 508 leverages advanced automatic discovery capabilities that analyze source code at build time to infer framework usage and function purposes. The execution plan generation system 106 inspects code structure, library imports, function signatures, and dependency declarations to automatically discover language model frameworks used in function definitions, such as identifying LangChain callback mechanisms, LlamaIndex service context patterns, or CrewAI agent instantiation methods without requiring explicit developer declarations. In these automatically-derived scenarios, the reasoning prompt construction becomes more sophisticated, incorporating inferred functionality descriptions. For instance, the execution plan generation system 106 might generate a prompt like: “Based on dynamic code analysis, the available workflow includes: (1) detected LangChain ReAct agent with inferred capabilities for multi-step reasoning and tool calling, (2) automatically discovered Pinecone vector retrieval function with input schema {query: string, top\_k: integer}, (3) inferred data processing function with pattern-matched capabilities for JSON manipulation. Given user request ‘Conduct comprehensive audit of customer service operations’ and detected agent objective of ‘customer support analytics,’ generate an execution plan that leverages these discovered capabilities.”

The reasoning prompt generation process combines user requests with comprehensive agent objectives and available resource inventories through contextual framing. The execution plan generation system 106 collects high-level descriptions of AI agent workflows to generate agent objectives, analyzes available resources including tools and functions accessible through function registration data, and constructs reasoning prompts that frame user requests within the context of these objectives and resources. For complex multi-step scenarios, the reasoning model 508 might receive prompts such as: “User Request: ‘Analyze team progress on Acme Corp project and identify improvement areas.’ Agent Objective: ‘Project management and progress tracking with focus on deliverable completion and resource optimization.’ Available Resources: JIRA API integration (inputs: project\_name, date\_range, status\_filter), resource allocation analyzer (inputs: team\_data, project\_timeline), progress reporting generator (inputs: jira\_data, resource\_data, output\_format). Generate a detailed execution plan specifying: Step 1—tool selection and parameters, Step 2—data processing sequence, Step 3—analysis operations, Step 4—report generation with specific output formatting.” This comprehensive prompt structure enables the reasoning model to create execution plans that specify which tools should be called at each step along with required input parameters and expected outputs, ensuring seamless handoff to instruction-following models for efficient workflow execution.

When the reasoning model 508 generates an execution plan, the reasoning model 508 creates a structured sequence of actionable steps that break down the user request 506 into specific tasks to be executed by the AI agent workflows 116. For instance, when processing a sales analysis request, the reasoning model 508 may generate a plan specifying “Step 1: Use Tool 1 (sales data retriever) to fetch Q4 sales metrics from the CRM system with parameters {time_period: ‘Q4_2024’, metrics: [‘revenue’, ‘conversion_rates’, ‘customer acquisition’]}. Step 2: Use Tool 3 (analytics processor) to perform comparative analysis against Q3 performance with input parameters from Step 1 results.” This execution plan provides the AI agent workflows 116 with a comprehensive roadmap that enables instruction-following models to execute workflow operations efficiently without requiring complex reasoning during execution.

The AI agent workflows 116 represent the target systems that receive and execute the plans generated by the reasoning model 508, encompassing agents built using different frameworks such as LangChain, LlamaIndex, CrewAI, or Semantic Kernel. These AI agent workflows 116 may include any combination of agents, tools, language models, retrievers, and other components that can be enhanced through reasoning wrapper deployment. The AI agent workflows 116 benefit from the separation of planning and execution operations, where reasoning models handle the complex thinking and decomposition while instruction-following models within the AI agent workflows 116 focus on efficient tool calling and response synthesis according to the provided execution plans.

The execution plan generation system 106 enables automatic type conversion capabilities that ensure seamless integration between reasoning model 508 outputs and the input requirements of AI agent workflows 116. When the reasoning model 508 generates execution plans containing tool invocation specifications formatted as natural language descriptions, the system automatically converts these into structured data types required by target functions. For example, the system may transform reasoning model output like “retrieve tickets with high priority” into properly formatted API calls with specific parameter values such as {“priority”: “high”, “status”: “open” }, ensuring compatibility across different framework implementations while maintaining the separation between planning operations and execution operations.

The dynamic function introspection process that populates function descriptions 504 operates by analyzing registered functions at build time to collect comprehensive metadata about available workflow components. This process may involve inspecting input schemas, output schemas, descriptions, and entry points from tools, agents, and functions used in AI agent workflows 116, building a complete understanding of how functions could utilize available resources. When developers register functions with the system by defining these schemas and descriptions, the information gets stored in a builder registry that maintains details about tools, agents, and functions used across different AI agent frameworks, enabling the reasoning model 508 to generate contextually appropriate execution plans.

In some embodiments, advanced implementations may incorporate behavioral profiling capabilities that enhance execution plan generation accuracy over time through continuous monitoring of AI agent workflows 116 execution patterns. The execution plan generation system 106 may build behavioral profiles by analyzing historical performance data to identify common failure scenarios and bottlenecks, then incorporating these behavioral insights into prompt construction for the reasoning model 508. For example, if the system observes that customer service workflows frequently encounter issues with specific tool interactions, the reasoning model 508 may generate execution plans that include additional cautionary guidance or alternative approaches to prevent known error scenarios.

The configuration-driven reasoning wrapper deployment allows developers to enhance AI agent workflows 116 with planning capabilities through simple configuration file specifications rather than manual programming. Users may selectively apply reasoning wrappers at multiple levels of workflow hierarchy, such as wrapping entire agents, individual tools, or specific workflow components based on configuration parameters specified in the function descriptions 504. This configurability enables flexible deployment scenarios where reasoning capabilities can be applied precisely where needed, such as applying reasoning wrappers only to high-level decision-making functions while leaving routine data processing tasks unwrapped, or alternatively wrapping tool interactions with planning capabilities to improve accuracy in complex scenarios.

The execution plan validation and refinement capabilities may include implementation of validation models that check logical consistency of generated plans before execution by AI agent workflows 116 begins. These validation mechanisms may analyze execution plans for non-sequitur elements or logical errors and route invalid portions back to the reasoning model 508 to generate revised execution plans. The system may also support self-reflection mechanisms where reasoning models critique and validate their own generated plans, executing iterative plan refinement cycles to improve execution plan quality and determining when additional reasoning iterations are necessary based on plan complexity and confidence levels.

The framework-agnostic capabilities enable the system to work across heterogeneous AI agent workflows 116 implementations regardless of their underlying framework origins. The system may coordinate execution plan implementation across different framework environments, maintaining execution context and data flow consistency between different framework components while providing unified interfaces for cross-framework function communication and data exchange. This abstraction allows developers to leverage efficiency gains from model separation, such as using reasoning models for planning and instruction-following models for execution, while maintaining comprehensive configurability and cross-framework compatibility across their entire agent ecosystem.

Conditional execution logic may be incorporated into execution plans generated by the reasoning model 508 to enable dynamic adaptation during workflow execution by AI agent workflows 116. The reasoning model 508 may include conditional statements in execution plans that specify alternative instruction sequences based on expected outcomes, error conditions, or performance criteria not being met. For example, execution plans may include predefined alternative approaches such as “if the JIRA query returns no results, then attempt the search with broader parameters” or “if the database connection fails, switch to the backup data source and retry the operation,” enabling instruction-following models to handle unexpected scenarios without requiring additional reasoning during execution.

The execution plan generation system 106 may implement monitoring and feedback mechanisms that track execution of execution plans by AI agent workflows 116, detecting execution results including errors or failures during plan execution. This monitoring generates feedback data that can be provided to the reasoning model 508 for improving subsequent plan generation, creating a self-improving cycle that enhances plan quality through iterative feedback and refinement. For example, when processing a customer service workflow that includes JIRA ticket retrieval and analysis tools, the monitoring system may detect that execution plans consistently fail when attempting to query JIRA with overly broad search parameters, resulting in timeout errors or empty result sets. The execution plan generation system 106 captures these failure patterns (e.g., via the results 422) along with the specific tool invocation parameters that led to the errors, then feeds this information back to the reasoning model 508 as contextual guidance. During subsequent plan generation for similar requests, the reasoning model incorporates this learned behavior by generating execution plans that include more specific search criteria, such as “if JIRA query returns no results with broad parameters, retry with customer-specific tags and date range filters,” thereby preventing the same failure scenarios from recurring.

The feedback loop enables the reasoning model 508 to learn from execution patterns and common edge cases during plan generation, proactively including appropriate conditional branches and creating execution plans that are resilient to typical workflow disruptions. In practice, this manifests as the system building behavioral profiles of different agent workflows through continuous monitoring, analyzing which tool combinations frequently succeed or fail under specific conditions, and incorporating this intelligence into future execution plans. For instance, if the system observes that database connection tools often fail during peak usage hours (3-5 PM), the reasoning model 508 begins generating execution plans that include conditional logic such as “if database connection fails, wait 30 seconds and retry using backup connection pool, then proceed with cached data if both fail.” Similarly, when workflows involve external API integrations that occasionally return rate-limiting errors, the feedback mechanism teaches the reasoning model to generate plans with built-in retry logic and alternative tool sequences, ensuring that instruction-following models can handle these disruptions gracefully without requiring additional reasoning cycles during execution.

Tool dependency analysis capabilities may enable the reasoning model 508 to understand relationships and dependencies between different tools available in the function descriptions 504, generating execution plans that account for proper sequencing and data flow between tools used by AI agent workflows 116. The execution plan generation system 106 may maintain comprehensive understanding of workflow composition and tool dependencies, enabling intelligent execution plan generation regardless of whether workflows span multiple frameworks or utilize different implementation approaches. This understanding allows the reasoning model 508 to generate plans where each tool's output serves as contextual input for subsequent operations, enabling instruction-following models to execute complex business processes with full workflow coordination.

Automatic metadata enhancement capabilities may augment the function descriptions 504 through continuous learning and observation of AI agent workflows 116 behavior during execution. The system may track tool performance and reliability metrics across different execution contexts, updating tool descriptions automatically based on observed performance characteristics and providing dynamic tool recommendations based on current system load and tool availability. This enhancement process ensures that the function descriptions 504 remain current and accurate, enabling the reasoning model 508 to generate increasingly effective execution plans as the system gains more operational experience with different tools and workflow configurations.

The multi-level reasoning wrapper deployment demonstrated in FIG. 5 enables granular control over where planning capabilities are applied within AI agent workflows 116, allowing developers to wrap individual functions, complete workflow segments, or entire agent implementations based on specific requirements defined in function descriptions 504. This selective application may be configured through the system's configuration files, where developers can specify which tool categories or functions receive reasoning enhancement for different types of user requests 506. The reasoning model 508 can generate targeted execution plans that utilize only the tools whose capabilities align with specific task requirements, demonstrating intelligent tool selection that optimizes efficiency by utilizing only necessary workflow components while maintaining comprehensive planning capabilities.

Real-time adaptation capabilities may enable the system to modify execution plans dynamically based on runtime conditions encountered during AI agent workflows 116 execution. The reasoning model 508 may generate execution plans that include decision points where the plan can branch based on intermediate results or changing conditions, allowing the AI agent workflows 116 to adapt their execution approach without requiring additional planning cycles. This adaptation mechanism ensures that execution plans remain effective even when workflows encounter unexpected scenarios or when tool availability changes during runtime, maintaining the separation between planning operations and execution operations while providing robust error handling and adaptive behavior throughout the workflow execution process.

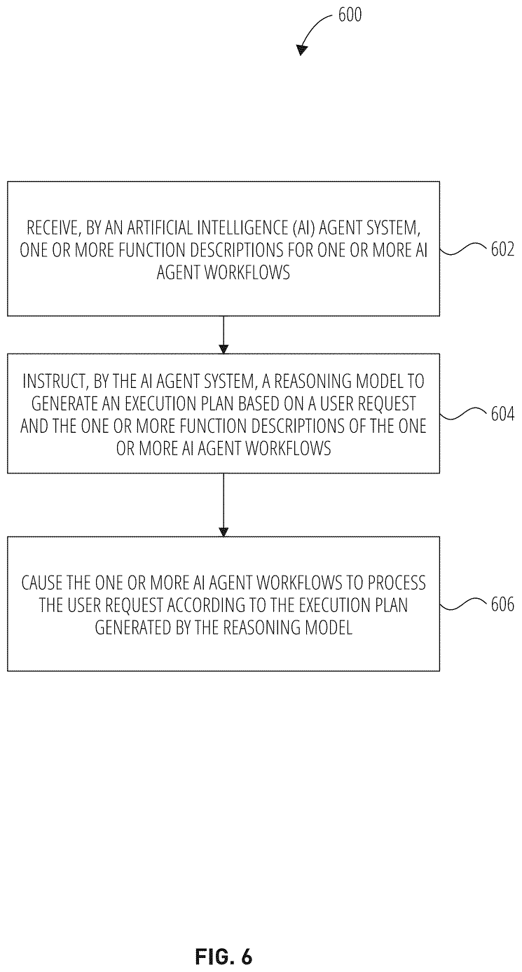

Now referring to FIG. 6, each block (or operation) of method 600, described herein, comprises a computing process that may be performed using any combination of hardware, firmware, and/or software. For instance, various functions may be carried out using one or more processors executing instructions stored in one or more memories. The method 600 may also be embodied as computer-usable instructions stored on computer storage media. The method 600 may be provided by a standalone application, a service or hosted service (standalone or in combination with another hosted service), as a microservice via an application programming interface (API), or a plug-in to another product, to name a few. In addition, the method 600 is described, by way of example, with respect to the AI agent system 104 of FIG. 1. However, this method 600 may additionally or alternatively be executed by any one system, or any combination of systems, including, but not limited to, those described herein. Specifically, the method 600 can be performed by any component shown in FIG. 1.

At operation 602, the AI agent system 104 receives one or more function descriptions for one or more AI agent workflows 116. This operation involves collecting comprehensive metadata about available tools, agents, and functions that comprise the target workflows. The function descriptions may include input schemas, output schemas, detailed descriptions, and entry points for each registered function within the AI agent workflows 116. The AI agent system 104 may obtain these function descriptions through multiple mechanisms, including explicit developer registration where developers define input schemas, output schemas, descriptions, and entry points for each function, storing this function information in a builder registry that maintains details about tools, agents, and functions used in the AI agent workflows. Alternatively, the system may employ automatic discovery capabilities that analyze source code at build time to infer framework usage and function purposes, inspecting code structure, library imports, function signatures, and dependency declarations to automatically discover language model frameworks used in function definitions such as LangChain callback mechanisms, LlamaIndex service context patterns, or CrewAI agent instantiation methods without requiring explicit developer declarations.

At operation 604, the AI agent system 104 instructs a reasoning model to generate an execution plan based on a user request and the one or more function descriptions of the AI agent workflows. This operation involves prompt construction that combines user requests with comprehensive agent objectives and available resource inventories of the AI agent workflows 116. The system collects high-level descriptions of AI agent workflows 116 to generate agent objectives, analyzes available resources including tools and functions accessible through function registration data, and constructs reasoning prompts that frame the user request within the context of these objectives and resources. The reasoning prompt generation process represents a component that involves contextual framing, where the system may generate prompts such as: “Given the user request ‘analyze our team's progress on the Acme Corp project,’ the agent's objective of ‘project management and progress tracking,’ and available tools including JIRA integration functions, resource allocation tools, and reporting capabilities, generate a comprehensive execution plan that specifies which tools should be called at each step along with required input parameters and expected outputs.” The reasoning model, which may utilize large language models that excel at complex planning, iterative decomposition, and breaking down bigger problems into series of actionable steps, processes these prompts to create structured execution plans that specify which tools or functions should be called at each step along with corresponding input parameters.

At operation 606, the AI agent system 104 (e.g., the execution plan generation system 106) causes the one or more AI agent workflows to process the user request according to the execution plan generated by the reasoning model. This operation enables seamless handoff between planning operations performed by reasoning models and execution operations performed by instruction-following models. The AI agent system 104 passes the generated execution plan along with the original user request to the target workflow functions, allowing instruction-following models (e.g., the AI agent workflows 116) to execute the structured plans efficiently without requiring complex reasoning during execution. The execution plan serves as a comprehensive roadmap that includes a structured execution sequence of actionable steps that break down the user request into specific tasks, a list of tools or functions to be called at multiple steps along with corresponding input parameters, instructions for tool invocations including specific input types and expected outputs for each step, and an order of execution steps and dependencies between different workflow components to accomplish the user request. The system automatically performs type conversions between reasoning model outputs and downstream workflow function inputs through dynamic inspection of function signatures and data types, ensuring compatibility across different framework implementations while maintaining the separation between planning operations and execution operations. This approach enables AI agent workflows 116 to benefit from enhanced planning capabilities while maintaining compatibility with existing agent implementations through standardized wrapper mechanisms and automatic type conversion capabilities, ultimately improving performance on complex queries while reducing token usage and execution time.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems using or deploying one or more inference microservices, systems incorporating one or more machine learning models deployed in a service or microservice along with an OS-level virtualization package; systems incorporating one or more virtual machines (VMs), systems for performing synthetic data generation operations (e.g., using one or more neural rendering fields (NERFs), Gaussian splat techniques, diffusion models, transformer models, etc.), systems implemented at least partially in a data center, systems for performing conversational AI operations, systems implementing one or more language models—such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models (e.g., the AI agent workflows 116), such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with a large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not need task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model-alignment techniques. For example, in some embodiments, guardrails may be implemented to identify improper or undesired inputs (e.g., prompts) and/or outputs of the models. In doing so, the system may use the guardrails and/or other model-alignment techniques to either prevent a particular undesired input from being processed using the LLMs/SLMs/VLMs/MMLMs/etc., and/or preventing the output or presentation (e.g., display, audio output, etc.) of information generated using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MSLMs/MLMs/MMLMs/etc. may be configured to access or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., third-party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires or benefits from a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

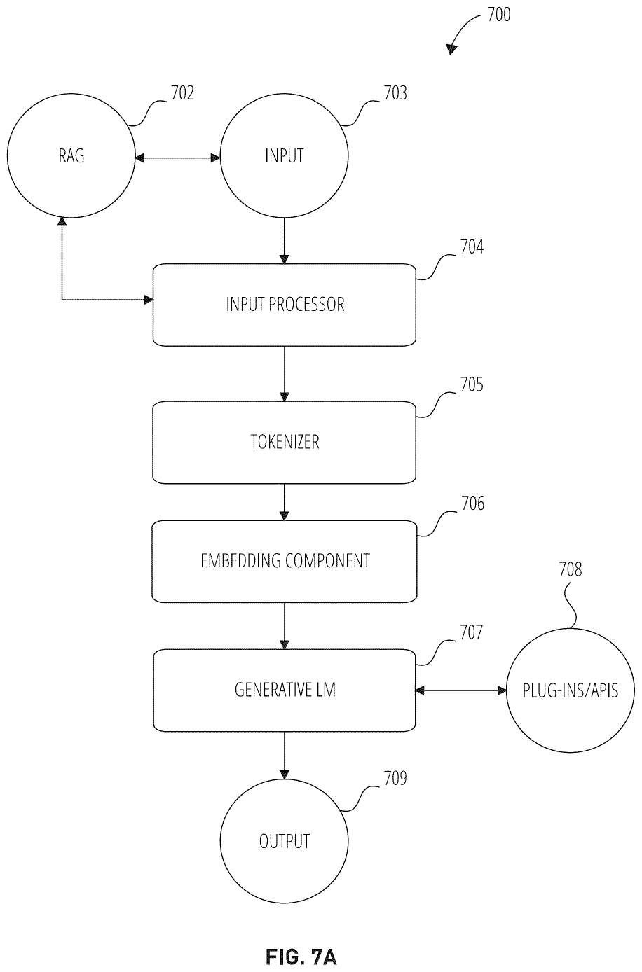

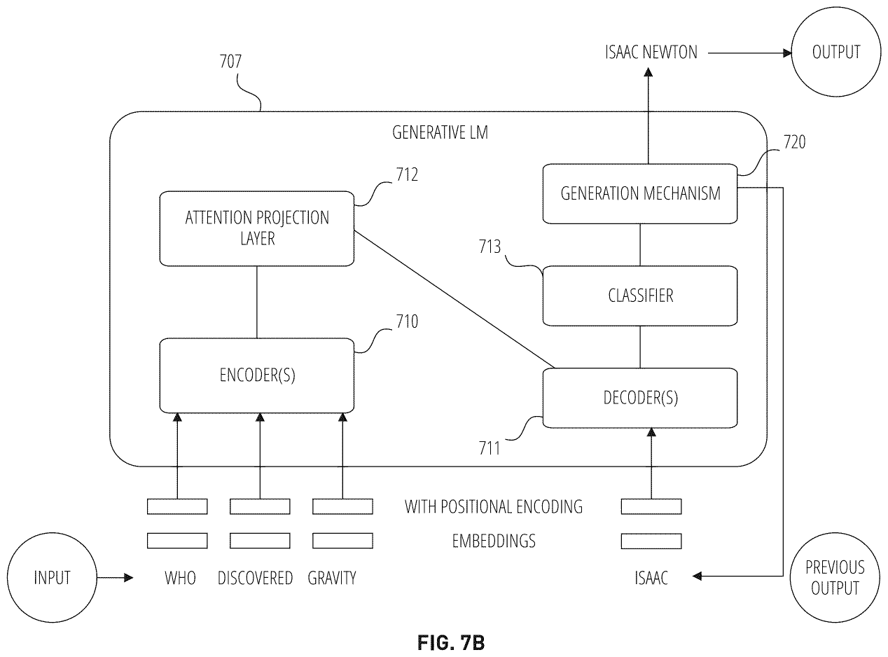

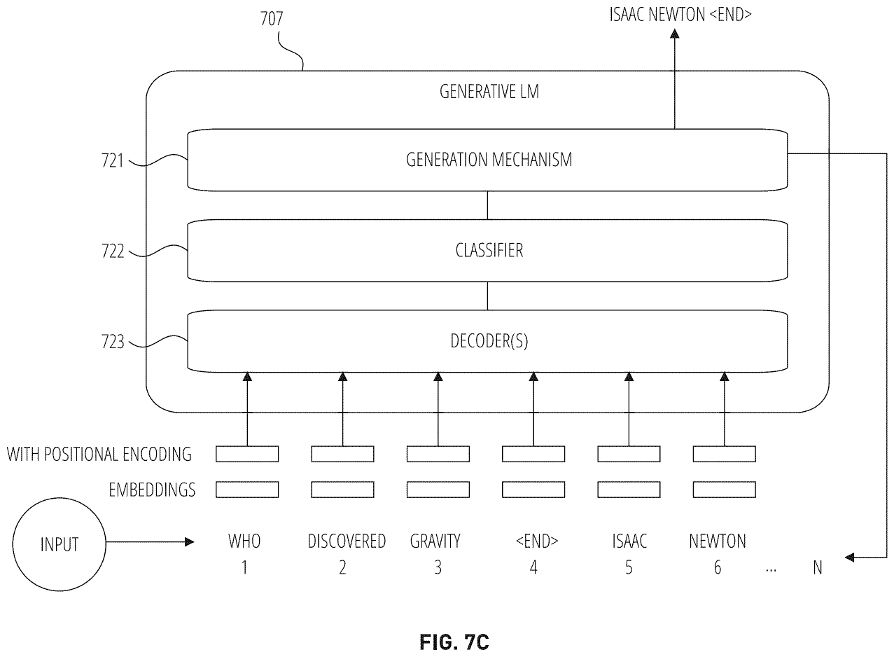

For example, and with reference to FIG. 7A, the generative LM 707 can access external resources through plug-ins/APIs 708 to enhance its capabilities beyond its internal knowledge base. When processing inputs, the generative LM 707 can intelligently determine when to utilize specific plug-ins/APIs 708 based on the requirements of the task. For example, when generating code, the generative LM 707 may access code execution environments through plug-ins/APIs 708 to test and validate solutions before providing them as output 709. The system enables coordinated use of multiple plug-ins/APIs 708 during generation, where the generative LM 707 can sequence different verification tools based on the specific requirements of the task. For instance, when solving mathematical problems, the generative LM 707 may first use symbolic computation plug-ins to verify equations, then access mathematical proof validation tools to check logical consistency, and finally employ formatting plug-ins to ensure proper mathematical notation in the output 709. This layered verification approach allows the generative LM 707 to produce outputs that are not only technically correct but also properly formatted and documented.

The plug-ins/APIs 708 integration is particularly valuable for verification tasks, as it allows the generative LM 707 to dynamically validate its outputs using domain-specific tools. For example, when generating code, the generative LM 707 can use syntax checkers, linters, and runtime environments accessed through plug-ins/APIs 708 to verify correctness, style, and execution behavior. The system can recursively apply these verification tools, using the feedback to refine the output 709 until it meets the required quality standards.

In some embodiments, multiple language models (e.g., LLMs/SLMs/VLMs/MMLMs/etc.) multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models, e.g., language models with different architectures and language models trained on different (e.g., updated) corpora of data, may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example non-limiting embodiments, the same language model may be asked to provide output corresponding to a different role, perspective, character, or having a different base of knowledge, etc., as defined by a supplied prompt.

In any one of such embodiments, the output of two or more (e.g., each) language models, two or more versions of at least one language model, two or more instanced agents of at least one language model, and/or two or more prompts provided to at least one language model may be further processed, e.g., aggregated, compared or filtered against, or used to determine (and provide) a consensus response. In one or more embodiments, the output from one language model—or version, instance, or agent—may be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 7A is a block diagram of an example generative LLM system, generative LLM system 700, suitable for use in implementing at least some embodiments of the present disclosure. In the example illustrated in FIG. 7A, the generative LLM system 700 includes a retrieval augmented generation (RAG) component 702, an input processor 704, a tokenizer 705, an embedding component 706, a generative LM 707 (which may include an LLM, a SLM, a VLM, a multi-modal LM, etc.), and plug-ins/APIs 708.

At a high level, the input processor 704 may receive an input 703 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 707 (e.g., LLM/SLM/VLM/MMLM/etc.). In some embodiments, the input 703 includes plain text in the form of one or more sentences, paragraphs, and/or documents. Additionally or alternatively, the input 703 may include numerical sequences, precomputed embeddings (e.g., word or sentence embeddings), and/or structured data (e.g., in tabular formats, JSON, or XML). In some implementations in which the generative LM 707 is capable of processing multi-modal inputs, the input 703 may combine text (or may omit text) with image data, audio data, video data, design data, USD data, and/or other types of input data, such as but not limited to those described herein. Taking raw input text as an example, the input processor 704 may prepare raw input text in various ways. For example, the input processor 704 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 704 may remove stopwords to reduce noise and focus the generative LM 707 on more meaningful content. The input processor 704 may apply text normalization, for example, by converting all characters to lowercase, removing accents, and/or handling special cases like contractions or abbreviations to ensure consistency. These are just a few examples, and other types of input processing may be applied.

In some embodiments, a RAG component 702 (which may include one or more RAG models, and/or may be performed using the generative LM 707 itself) may be used to retrieve additional information to be used as part of the input 703 or prompt. The RAG component 702 may be used to enhance the input to the LLM/SLM/VLM/MMLM/etc. with external knowledge, so that answers to specific questions or queries or requests are more relevant—such as in a case where specific knowledge is involved. The RAG component 702 may fetch this additional information (e.g., grounding information, such as grounding text/image/video/audio/USD/CAD/etc.) from one or more external sources, which can then be fed to the LLM/SLM/VLM/MMLM/etc. along with the prompt to improve the accuracy of the responses or outputs of the model.

For example, in some embodiments, the input 703 may be generated using the query or input to the model (e.g., a question, a request, etc.) in addition to data retrieved using the RAG component 702. In some embodiments, the input processor 704 may analyze the input 703 and communicate with the RAG component 702 (or the RAG component 702 may be part of the input processor 704, in embodiments) in order to identify relevant text and/or other data to provide to the generative LM 707 as additional context or sources of information from which to identify the response, answer, or output 709, generally. For example, where the input 703 indicates that the user is interested in a desired tire pressure for a particular make and model of vehicle, the RAG component 702 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 702 may retrieve a prior stored conversation history—or at least a summary thereof—and include the prior conversation history along with the current ask/request as part of the input 703 to the generative LM 707.

For example, in some embodiments, the input 703 may be generated using the query or input to the model (e.g., a question, a request, etc.) in addition to data retrieved using the RAG component 702. This integration creates a comprehensive input package that combines the original task requirements with contextually relevant information for evaluation. The input 703 can take various forms, such as a structured data object containing multiple elements: the original query or task description, verification criteria for the AI agent workflows 116, and relevant reference information retrieved by the RAG component 702. When processing a task like “Implement a binary search tree insertion algorithm,” the input 703 can include not only this request but also relevant documentation, test cases, and performance metrics that the AI agent workflows 116 will use to assess the generated solution.

The input processor 704 analyzes this enriched input package and communicates with the RAG component 702 to identify additional verification resources needed for comprehensive evaluation. The input processor 704 may analyze task characteristics to determine which verification approaches are most or likely most appropriate and prepares the contextual information needed for thorough evaluation.

The RAG component 702 might also retrieve historical evaluation data from previous optimization cycles. For instance, if a particular type of prompt has consistently led to higher-quality outputs in similar domains, the RAG component 702 can retrieve this historical context to inform the current optimization strategy. This ensures continuous improvement across evaluation sessions while applying lessons learned from previous optimization attempts. The AI agent system 104 orchestrates this process by determining which historical optimization data is relevant to the current task and how it should influence parameter adjustments, creating a self-improving system that progressively enhances output quality through intelligent evaluation and targeted refinement.

The RAG component 702 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 702 and the embeddings of the chunks along with the embeddings of the query may be compared to identify the most similar/related embeddings to the query, which may be supplied to the generative LM 707 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query)-to-graph query tool (NL-to-graph query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 702 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 705 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 707 to understand morphological variations and handle out-of-vocabulary words more effectively. Character-based tokenization represents each character as a separate token, enabling the generative LM 707 to process text at a fine-grained level. The choice of tokenization strategy may depend on factors such as the language being processed, the task at hand, and/or characteristics of the training dataset. As such, the tokenizer 705 may convert the (e.g., processed) text into a structured format according to tokenization schema being implemented in the particular embodiment.

The embedding component 706 may use any known embedding technique to transform discrete tokens into (e.g., dense, continuous vector) representations of semantic meaning. For example, the embedding component 706 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 703 includes image data/video data/etc., the input processor 704 may resize the data to a standard size compatible with the format of a corresponding input channel and/or may normalize pixel values to a common range (e.g., 0 to 1) to ensure a consistent representation, and the embedding component 706 may encode the image data using any known technique (e.g., using one or more convolutional neural networks (CNNs) to extract visual features). In some implementations in which the input 703 includes audio data, the input processor 704 may resample an audio file to a consistent sampling rate for uniform processing, and the embedding component 706 may use any known technique to extract and encode audio features—such as in the form of a spectrogram (e.g., a mel-spectrogram). In some implementations in which the input 703 includes video data, the input processor 704 may extract frames or apply resizing to extracted frames, and the embedding component 706 may extract features such as optical flow embeddings or video embeddings and/or may encode temporal information or sequences of frames. In some implementations in which the input 703 includes multi-modal data, the embedding component 706 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 707 and/or other components of the generative LLM system 700 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying nonlinear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 706 may apply an encoded representation of the input 703 to the generative LM 707, and the generative LM 707 may process the encoded representation of the input 703 to generate an output 709, which may include responsive text and/or other types of data.

As described herein, in some embodiments, the generative LM 707 may be configured to access or use—or be capable of accessing or using—plug-ins/APIs 708 (which may include one or more plug-ins, application programming interfaces (APIs), databases, data stores, repositories, etc.). For example, for certain tasks or operations that the generative LM 707 is not ideally suited for, the model may have instructions (e.g., as a result of training, and/or based on instructions in a given prompt, such as those retrieved using the RAG component 702) to access one or more plug-ins/APIs 708 (e.g., third-party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-ins/APIs 708 to the plug-ins/APIs 708, the plug-ins/APIs 708 may process the information and return an answer to the generative LM 707, and the generative LM 707 may use the response to generate the output 709. This process may be repeated—e.g., recursively—for any number of iterations and using any number of plug-ins/APIs 708 until an output 709 that addresses each ask/question/request/process/operation/etc. from the input 703 can be generated. As such, the model(s) may not only rely on its own knowledge from training on a large dataset(s) and/or from data retrieved using the RAG component 702, but also on the expertise or optimized nature of one or more external resources—such as the plug-ins/APIs 708.

The generative LM 707 can access external resources through plug-ins/APIs 708 to enhance its capabilities beyond its internal knowledge base. This integration is particularly valuable in evaluation and optimization workflows performed by the AI agent system 104, where the generative LM 707 may need to verify outputs or access specialized domain knowledge. When processing complex coding tasks, for instance, the generative LM 707 can identify syntax patterns in user input and automatically initiate API calls to code verification tools like interpreters or linters, incorporating proper programming standards while preserving the original output structure. The system may recursively query multiple specialized verification resources—progressing from code execution to syntax validation and finally to style analysis—before generating comprehensive evaluation data that maintains output quality while incorporating expert verification signals.

In optimization implementations, the system orchestrates complementary verification through targeted API integrations, allowing the generative LM 707 to access code interpreters for functional validation while simultaneously querying style checkers and mathematical validators when appropriate. This coordinated multi-source integration creates comprehensive evaluation perspectives impossible with single-source information models, while maintaining consistent output quality assessment. Similarly, in mathematical verification contexts, the generative LM 707 can reference symbolic problem solvers through API connections, execute computational verifications through code interpreters, and verify logical consistency through mathematical validation tools—all while maintaining its evaluation objectives and optimization goals within a coherent evaluation-optimization cycle.

Furthermore, the plugin integration architecture supports conditional access patterns where verification tools are dynamically selected based on the output domain. The input processor 704 can be configured through the API call structure to implement rules such as “use code interpreters when programming outputs are detected” or “reference mathematical validators when processing proofs.” The generative LM 707 processes these different plugin response streams within the context of the evaluation objectives, enabling sophisticated verification processes where multiple tools can build upon each other's verification signals while maintaining consistent evaluation standards. This approach significantly enhances the evaluation accuracy beyond what either standard comparison or single-tool verification can achieve, as the system maintains both comprehensive verification capabilities and access to specialized knowledge resources appropriate to each output domain.

In some embodiments, reasoning models and instruction-following models may be implemented as components within AI agent workflows 116 that operate across multiple agent frameworks, requiring comprehensive reasoning wrapper deployment and execution plan generation capabilities that extend beyond traditional manual integration approaches. The AI agent system 104 described herein enables framework-agnostic reasoning wrapper functionality and dynamic function introspection of these language model implementations regardless of whether they are deployed within LangChain, LlamaIndex, CrewAI, Semantic Kernel, or other agent framework environments. This approach allows developers to obtain unified planning and execution capabilities across heterogeneous agent architectures where different reasoning models may be integrated with various tools, retrievers, and memory components, creating complex multi-framework workflows that require standardized reasoning wrapper deployment methodologies.

The language models operating within these AI agent workflows 116 may be subject to comprehensive reasoning wrapper integration through automated function introspection that captures input schemas, output schemas, descriptions, and entry points during workflow registration. The system may register dynamic function inspection capabilities that analyze framework implementations including function definitions, tool integrations, and workflow compositions, extracting relevant metadata such as function names, descriptions, data types, and execution parameters from each registered component. This metadata extraction occurs transparently without requiring modifications to the underlying language model implementations, enabling developers to deploy reasoning wrapper functionality including execution plan generation, automatic type conversion, conditional logic integration, and workflow coordination across different stages of agent workflow execution.

Furthermore, the reasoning wrapper deployment capabilities may include configuration-driven integration where language models are enhanced with planning capabilities through simple configuration file specifications rather than manual programming requirements. The system may generate structured execution plans that capture comprehensive workflow understanding, enabling separation of reasoning operations performed by planning models from instruction-following operations performed by execution models across concurrent agent workflow implementations. These comprehensive reasoning wrapper insights enable optimization of language model deployment strategies, prompt engineering approaches, and resource allocation decisions while maintaining compatibility with existing agent implementations through standardized wrapper mechanisms that support automatic type conversion and cross-framework integration capabilities.

FIG. 7B is a block diagram of an example implementation in which the generative LM 707 includes a transformer encoder-decoder. For example, assume input text such as “Who discovered gravity” is tokenized (e.g., by the tokenizer 705 of FIG. 7A) into tokens such as words, and each token is encoded (e.g., by the embedding component 706 of FIG. 7A) into a corresponding embedding. Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 710 of the generative LM 707.

In an example implementation, the encoder(s) 710 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, and a self-attention score may be calculated for pairs of tokens by taking the dot product of the query vector with the corresponding key vectors, normalizing the resulting scores, multiplying by corresponding value vectors, and summing weighted value vectors. The encoder 710 may apply multi-headed attention in which the attention mechanism is applied multiple times in parallel with different learned weight matrices. Any number of encoders may be cascaded to generate a context vector encoding the input. An attention projection layer 712 may convert the context vector into attention vectors (keys and values) for the decoder(s) 711.

In an example implementation, the decoder(s) 711 form a decoder stack, where each decoder includes a self-attention layer, an encoder-decoder self-attention layer that uses the attention vectors (keys and values) from the encoder 710 to focus on relevant parts of the input sequence, and a feedforward network. As with the encoder(s) 710, in an example transformer architecture, each token (e.g., word) flows through a separate path in the decoder(s) 711. During a first pass, the decoder(s) 711, a classifier 713, and a generation mechanism 720 may generate a first token, and the generation mechanism 720 may apply the generated token as an input during a second pass. The process may repeat in a loop, successively generating and adding tokens (e.g., words) to the output from the preceding pass and applying the token embeddings of the composite sequence with positional encodings as an input to the decoder(s) 711 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 710, except that it creates its queries from the layer below it and takes the keys and values (e.g., matrix) from the output of the encoder(s) 710.

As such, the decoder(s) 711 may output some decoded (e.g., vector) representation of the input being applied during a particular pass. The classifier 713 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 720 may select or sample a word or token based on a corresponding predicted probability (e.g., select the word with the highest predicted probability) and append it to the output from a previous pass, generating each word or token sequentially. The generation mechanism 720 may repeat the process, triggering successive decoder inputs and corresponding predictions until selecting or sampling a symbol or token that represents the end of the response, at which point the generation mechanism 720 may output the generated response.

FIG. 7C is a block diagram of an example implementation in which the generative LM 707 includes a decoder-only transformer architecture. For example, the decoder(s) 723 of FIG. 7C may operate similarly as the decoder(s) 711 of FIG. 7B except each of the decoder(s) 723 of FIG. 7C omits the encoder-decoder self-attention layer (since there is no encoder in this implementation). As such, the decoder(s) 723 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 723. As with the decoder(s) 711 of FIG. 7B, each token (e.g., word) may flow through a separate path in the decoder(s) 723, and the decoder(s) 723, a classifier 722, and a generation mechanism 721 may use auto-regression to sequentially generate one token at a time until predicting a symbol or token that represents the end of the response.

The classifier 722 and the generation mechanism 721 may operate similarly to the classifier 713 and the generation mechanism 720 of FIG. 7B, with the generation mechanism 721 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

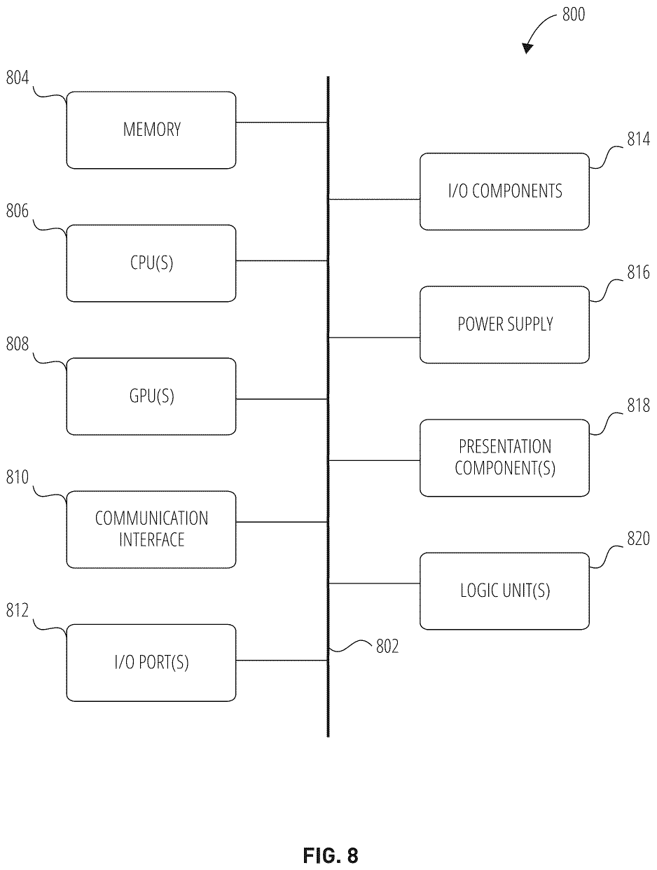

FIG. 8 is a block diagram of an example computing device 800 suitable for use in implementing some embodiments of the present disclosure. The computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output (I/O) components 814, a power supply 816, one or more presentation component(s) 818 (e.g., display(s)), and one or more logic unit(s) 820. In at least one embodiment, the computing device 800 may comprise one or more virtual machines (VMs), and/or any of the components thereof may comprise virtual components (e.g., virtual hardware components). For non-limiting examples, one or more of the GPU(s) 808 may comprise one or more vGPUs, one or more of the CPU(s) 806 may comprise one or more vCPUs, and/or one or more of the logic unit(s) 820 may comprise one or more virtual logic units. As such, a computing device 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component(s) 818, such as a display device, may be considered an I/O components 814 (e.g., if the display is a touch screen). As another example, the CPU(s) 806 and/or GPU(s) 808 may include memory (e.g., the memory 804 may be representative of a storage device in addition to the memory of the GPU(s) 808, the CPU(s) 806, and/or other components). As such, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU(s) 806 may be directly connected to the memory 804. Further, the CPU(s) 806 may be directly connected to the GPU(s) 808. Where there is direct, or point-to-point connection between components, the interconnect system 802 may include a PCIe link to carry out the connection. In these examples, a PCI bus need not be included in the computing device 800. The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

In some embodiments specifically related to implementing the AI agent system 104 described in FIG. 1, the computing device 800 may be configured to provide framework-agnostic performance analysis of AI agent workflows 116 through automated instrumentation and standardized profiling capabilities. The memory 804 may store custom callback handlers, intermediate step stream data, and standardized metadata extracted from different agent frameworks, while maintaining execution traces and performance metrics collected during multi-concurrency workflow analysis. The CPU(s) 806, GPU(s) 808, and/or logic unit(s) 820 may work cooperatively to perform the distinct functions of the AI agent system 104, including automatic framework discovery, callback handler registration for intercepting framework invocations across LangChain, LlamaIndex, CrewAI, and Semantic Kernel implementations, metadata normalization into unified data models, and execution of specialized profiling algorithms that generate latency analysis, bottleneck identification, concurrency analysis, and token efficiency measurements that provide granular insights into workflow performance characteristics previously impossible to obtain across heterogeneous agent implementations.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPU(s) 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU(s) 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic unit(s) 820 may be part of and/or integrated in one or more of the CPU(s) 806 and/or the GPU(s) 808 and/or one or more of the logic unit(s) 820 may be discrete components or otherwise external to the CPU(s) 806 and/or the GPU(s) 808. In embodiments, one or more of the logic unit(s) 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that allow the computing device 800 to communicate with other computing devices via an electronic communication network, including wired and/or wireless communications. The communication interface 810 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O port(s) 812 may allow the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may include one or more depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertial measurement unit (IMU)) that allow detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to allow the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

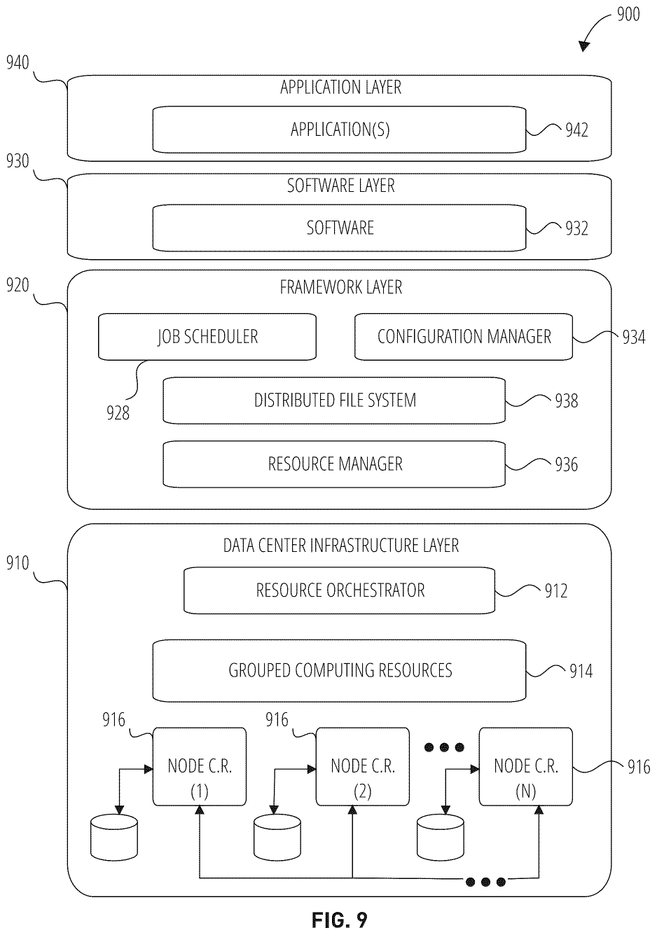

FIG. 9 illustrates an example data center 900 that may be used in at least one embodiment of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources 916 (“node C.R.s”), shown as (1)-(N), where “N” represents any whole, positive integer. In at least one embodiment, node computing resources 916 may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more nodes from among the node computing resources 916 may correspond to a server having one or more of the above-mentioned computing resources. In addition, in some embodiments, the node computing resources 916 may include one or more virtual components, such as vGPUs, vCPUs, and/or the like, and/or one or more of the node computing resources 916 may correspond to a virtual machine (VM).

In at least one embodiment, the grouped computing resources 914 may include separate groupings of the node computing resources 916 housed within one or more racks (not shown), or many racks housed in data centers at various geographical locations (also not shown). Separate groupings of node computing resources 916 within the grouped computing resources 914 may include grouped compute, network, memory or storage resources that may be configured or allocated to support one or more workloads. In at least one embodiment, several node computing resources 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node computing resources 916 and/or grouped computing resources 914. In at least one embodiment, the resource orchestrator 912 may include a software design infrastructure (SDI) management entity for the data center 900. The resource orchestrator 912 may include hardware, software, or some combination thereof.

In at least one embodiment, as shown in FIG. 9, the framework layer 920 may include a job scheduler 928, a configuration manager 934, a resource manager 936, and/or a distributed file system 938. The framework layer 920 may include a framework to support the software 932 of the software layer 930 and/or one or more application(s) 942 of the application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may use the distributed file system 938 for large-scale data processing (e.g., “big data”). In at least one embodiment, the job scheduler 928 may include a Spark driver to facilitate scheduling of workloads supported by various layers of the data center 900. The configuration manager 934 may be capable of configuring different layers such as the software layer 930 and the framework layer 920 including Spark and the distributed file system 938 for supporting large-scale data processing. The resource manager 936 may be capable of managing clustered or grouped computing resources mapped to or allocated for support of the distributed file system 938 and the job scheduler 928. In at least one embodiment, clustered or grouped computing resources may include the grouped computing resources 914 at the data center infrastructure layer 910. The resource manager 936 may coordinate with the resource orchestrator 912 to manage these mapped or allocated computing resources.

In at least one embodiment, the software 932 included in the software layer 930 may include software used by at least portions of the node computing resources 916, grouped computing resources 914, and/or the distributed file system 938 of the framework layer 920. One or more types of software may include, but are not limited to, Internet web page search software, e-mail virus scan software, database software, and streaming video content software.

In at least one embodiment, the application(s) 942 included in the application layer 940 may include one or more types of applications used by at least portions of the node computing resources 916, grouped computing resources 914, and/or distributed file system 938 of the framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of the configuration manager 934, resource manager 936, and resource orchestrator 912 may implement any number and type of self-modifying actions based on any amount and type of data acquired in any technically feasible fashion. Self-modifying actions may relieve a data center operator of the data center 900 from making possibly bad configuration decisions and possibly avoiding underutilized and/or poor performing portions of a data center. Each layer of the data center 900 contributes functionality to the AI agent system 104.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

The AI agent system 104 of FIG. 1 is designed to perform comprehensive task-agnostic reasoning wrapper deployment for AI agent workflows 116 across multiple deployment layers of the data center 900 without requiring modifications to existing agent implementations. The AI agent system 104 can automatically discover and enhance agent workflows built using different frameworks such as LangChain, LlamaIndex, CrewAI, and Semantic Kernel while maintaining complete workflow transparency through dynamic function introspection and execution plan generation across all layers of the data center 900 infrastructure.

At the application layer 940, the AI agent system 104 can enhance application(s) 942 that implement AI agent workflows 116 by deploying reasoning wrappers through configuration-driven integration that separates planning operations from execution operations. The API server 114 coordinates with application(s) 942 running at the application layer 940 to enable reasoning model integration during workflow execution, enabling the execution plan generation system 106 to create structured execution plans including dynamic function analysis, automatic type conversion capabilities, and contextual prompt construction that help developers enhance their agent implementations with planning capabilities across different deployment scenarios.

Within the software layer 930, the AI agent system 104 interfaces with software 932 components to perform dynamic function introspection including input schemas, output schemas, descriptions, and entry points from registered workflow functions. The execution plan generation system 106 works with the software layer 930 to construct reasoning prompts that frame user requests within context of agent objectives and available resources, enabling the reasoning wrapper component to generate comprehensive execution plans that capture workflow understanding including function capabilities and hierarchical relationships between workflow components.

At the framework layer 920, the AI agent system 104 coordinates with the job scheduler 928, configuration manager 934, and resource manager 936 to enable framework-agnostic reasoning wrapper deployment across heterogeneous agent implementations. The configuration 110 component works with the configuration manager 934 to define reasoning wrapper parameters, execution plan validation criteria, and type conversion specifications that guide the reasoning integration process. The execution plan generation system 106 leverages the distributed file system 938 to store execution plans and workflow composition data that enable comprehensive planning capabilities across multiple framework boundaries.

At the data center infrastructure layer 910, the AI agent system 104 communicates with the resource orchestrator 912 to coordinate reasoning wrapper deployment across grouped computing resources 914 and node computing resources 916 where agent workflows are deployed. The observability platform 126 exports execution plan data to workflow monitoring systems through the resource orchestrator 912, enabling cross-framework reasoning integration where agent workflows built in one framework can be enhanced with planning capabilities using reasoning models associated with different frameworks. The comprehensive reasoning wrapper capabilities enable the AI agent system 104 to provide granular workflow enhancement through execution plan generation previously impossible to obtain across multi-framework agent architectures deployed across the data center 900 infrastructure.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device 800 of FIG. 8—e.g., each device may include similar components, features, and/or functionality of the computing device 800. In addition, where backend devices (e.g., servers, NAS, etc.) are implemented, the backend devices may be included as part of the data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc.

A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or operations or combinations of steps or operations similar to the ones described in this document, in conjunction with other present or future technologies. Moreover, although the terms “step” and/or “block” and/or “operation” may be used herein to connote different elements of methods employed, the terms should not be interpreted as implying any particular order among or between various steps herein disclosed unless and except when the order of individual steps is explicitly described.

### EXAMPLES

Specific example embodiments are now described. In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1. One or more processors comprising processing circuitry to perform operations comprising: receiving, by an artificial intelligence (AI) agent system, one or more function descriptions corresponding to one or more functions available to one or more AI agent workflows; instructing, by the AI agent system, a reasoning model to generate an execution plan for a user request based at least on the one or more function descriptions corresponding to the one or more functions available to the one or more AI agent workflows; and causing the one or more AI agent workflows to process the user request by invoking at least one function of the one or more functions according to the execution plan.

Example 2. The one or more processors of Example 1, wherein the operations comprise: registering one or more functions with the AI agent system by defining input schemas, output schemas, descriptions, and entry points for each function; storing function information from the registering in a builder registry that maintains details about tools, agents, and functions used in the one or more AI agent workflows; collecting function registration data at build time from the stored function information to enable dynamic inspection of workflow components; and providing the AI agent system with the collected function registration data to enable reasoning operations to begin based on understanding of available workflow functions.

Example 3. The one or more processors of any one of Examples 1-2, wherein the operations comprise: wrapping one or more agent functions with standardized interfaces that define standardized input schemas, output schemas, and descriptions of the one or more AI agent workflows; and registering wrapped functions with the AI agent system that maintains information about tools, agents, and functions across different AI agent frameworks used to create the one or more AI agent workflows.

Example 4. The one or more processors of any one of Examples 1-3, wherein the operations comprise: inspecting source code of the one or more AI agent workflows to identify one or more undeclared agent frameworks; automatically discovering one or more language model (LM) frameworks used in function definitions of the one or more AI agent workflows by analyzing at least one of code structure or library imports; registering custom callback handlers for each identified undeclared agent framework to intercept framework invocations; and generating standardized data for the one or more AI agent workflows by extracting metadata including at least one of input data, output data, or token usage from the intercepted framework invocations through the custom callback handlers.

Example 5. The one or more processors of Example 4, wherein the operations comprise: normalizing the extracted metadata across different frameworks into a unified data model; and publishing the normalized metadata to an intermediate step stream.

Example 6. The one or more processors of any one of Examples 1-3, wherein the operations comprise: collecting one or more descriptions of the one or more AI agent workflows to generate one or more agent objectives; analyzing available resources comprising tools and functions accessible to the one or more AI agent workflows through function registration data; constructing a reasoning prompt for the reasoning model that frames the user request within context of the one or more agent objectives and the available resources; and passing the constructed reasoning prompt to the reasoning model for generating the execution plan.

Example 7. The one or more processors of any one of Examples 1-6, wherein the operations comprise: automatically detecting input and output data types of workflow functions of the one or more AI agent workflows; performing type conversions between outputs of the reasoning model and the input data types of the workflow functions; and transforming the output data types of the workflow functions.

Example 8. The one or more processors of any one of Examples 1-7, wherein the operations comprise: wrapping an individual function within the one or more AI agent workflows with reasoning capabilities; detecting that the individual function has been wrapped with reasoning capabilities; generating a prompt for the reasoning model that includes a description of the individual function to generate the execution plan for the individual function; and causing selective application of reasoning to specific workflow components of the one or more AI agent workflows.

Example 9. The one or more processors of Example 8, wherein the operations comprise: providing configuration options for applying reasoning at multiple levels of workflow hierarchy of the one or more AI agent workflows.

Example 10. The one or more processors of any one of Examples 1-8, wherein the operations comprise: processing one or more configuration files that specify reasoning wrapper parameters without additional programming for the one or more AI agent workflows; parsing configuration syntax of the one or more configuration files to select a portion of workflow components of the one or more AI agent workflows for reasoning; and applying reasoning wrappers automatically at runtime to the portion of the workflow components before executing operations of the one or more AI agent workflows.

Example 11. The one or more processors of Example 10, wherein the operations comprise: monitoring execution of the execution plan by the one or more AI agent workflows; detecting execution results comprising one or more errors or failures during execution of the execution plan; generating feedback data comprising the execution results; and providing feedback to the reasoning model for improving subsequent plan generation.

Example 12. The one or more processors of any one of Examples 10-11, wherein the operations comprise: implementing a validation model to check logical consistency of the execution plan before execution of the execution plan by the one or more AI agent workflows begins; analyzing the execution plan for non-sequitur elements or logical errors; and routing one or more invalid portions of the execution plan back to the reasoning model to generate a revised execution plan.

Example 13. The one or more processors of any one of Examples 10-12, wherein the operations comprise: building one or more behavioral profiles of the one or more AI agent workflows through continuous monitoring of execution patterns; analyzing historical performance data to identify one or more common failure scenarios or one or more bottlenecks of the one or more AI agent workflows; and incorporating the one or more behavioral profiles and the historical performance data into prompt construction for the reasoning model to generate the execution plan.

Example 14. The one or more processors of any one of Examples 1-13, wherein the execution plan comprises: a structured execution sequence of actionable steps that break down the user request into specific tasks to be executed by the one or more AI agent workflows; a list of tools or functions to be called at a plurality of steps of the execution sequence along with corresponding input parameters; instructions for tool invocations including specific input types and expected outputs for each step in the execution plan; an order of execution steps and dependencies between different workflow components to accomplish the user request; and a roadmap that enables instruction-following models to execute the execution plan.

Example 15. The one or more processors of any one of Examples 1-14, wherein the reasoning model comprises a language model (LM).

Example 16. The one or more processors of any one of Examples 1-15, wherein the one or more processors are comprised in at least one of: a control system for an autonomous or semi-autonomous machine; a perception system for the autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational artificial intelligence (AI) operations; a system implementing one or more multi-modal language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system incorporating one or more machine learning models deployed in a service or microservice along with an OS-level virtualization package; a system implemented at least partially in a data center; or a system implemented at least partially using cloud computing resources.

Example 17. A system comprising one or more processors to perform operations comprising: receiving, by an artificial intelligence (AI) agent system, one or more function descriptions corresponding to one or more functions available to one or more AI agent workflows; instructing, by the AI agent system, a reasoning model to generate an execution plan for a user request based at least on the one or more function descriptions corresponding to the one or more functions available to the one or more AI agent workflows; and causing the one or more AI agent workflows to process the user request by invoking at least one function of the one or more functions according to the execution plan.

Example 18. The system of Example 17, wherein the system is comprised in at least one of: a control system for an autonomous or semi-autonomous machine; a perception system for the autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational artificial intelligence (AI) operations; a system implementing one or more multi-modal language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system incorporating one or more machine learning models deployed in a service or microservice along with an OS-level virtualization package; a system implemented at least partially in a data center; or a system implemented at least partially using cloud computing resources.

Example 19. A method comprising: receiving, by an artificial intelligence (AI) agent system, one or more function descriptions corresponding to one or more functions available to one or more AI agent workflows; instructing, by the AI agent system, a reasoning model to generate an execution plan for a user request based at least on the one or more function descriptions corresponding to the one or more functions available to the one or more AI agent workflows; and causing the one or more AI agent workflows to process the user request by invoking at least one function of the one or more functions according to the execution plan.

Example 20. The method of Example 19, wherein the method is performed by at least one of: a control system for an autonomous or semi-autonomous machine; a perception system for the autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational artificial intelligence (AI) operations; a system implementing one or more multi-modal language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system incorporating one or more machine learning models deployed in a service or microservice along with an OS-level virtualization package; a system implemented at least partially in a data center; or a system implemented at least partially using cloud computing resources.

What is claimed is:

1. One or more processors comprising processing circuitry to perform operations comprising:
receiving, by an artificial intelligence (AI) agent system, one or more function descriptions of at least one available function for one or more AI agent workflows;
instructing, by the AI agent system, a reasoning model to generate an execution plan for a user request based at least on the one or more function descriptions of the at least one available function for the one or more AI agent workflows; and
causing the one or more AI agent workflows to process the user request according to the execution plan generated by the reasoning model.

2. The one or more processors of claim 1, wherein the operations comprise:
registering one or more functions with the AI agent system by defining schemas, descriptions, and entry points for each function;
storing function information from the registering in a builder registry that maintains details about tools, agents, and functions used in the one or more AI agent workflows;
collecting function registration data at build time from the stored function information to enable dynamic inspection of workflow components; and
providing the AI agent system with the collected function registration data to enable reasoning operations to begin based on understanding of available workflow functions.

3. The one or more processors of claim 1, wherein the operations comprise:
wrapping one or more agent functions with standardized interfaces that define standardized schemas and descriptions of the one or more AI agent workflows; and
registering wrapped functions with the AI agent system that maintains information about tools, agents, and functions across different AI agent frameworks used to create the one or more AI agent workflows.

4. The one or more processors of claim 1, wherein the operations comprise:
inspecting source code of the one or more AI agent workflows to identify one or more undeclared agent frameworks;
automatically discovering one or more language model (LM) frameworks used in function definitions of the one or more AI agent workflows by analyzing at least one of code structure or library imports;
registering custom callback handlers for each identified undeclared agent framework to intercept framework invocations; and
generating standardized data for the one or more AI agent workflows by extracting metadata including at least one of input data, output data, or token usage from the intercepted framework invocations through the custom callback handlers.

5. The one or more processors of claim 4, wherein the operations comprise:
normalizing the extracted metadata across different frameworks into a unified data model; and
publishing the normalized metadata to an intermediate step stream.

6. The one or more processors of claim 1, wherein the operations comprise:
collecting one or more descriptions of the one or more AI agent workflows to generate one or more agent objectives;
analyzing available resources comprising tools and functions accessible to the one or more AI agent workflows through function registration data;
constructing a reasoning prompt for the reasoning model that frames the user request within context of the one or more agent objectives and the available resources; and
passing the constructed reasoning prompt to the reasoning model for generating the execution plan.

7. The one or more processors of claim 1, wherein the operations comprise:
automatically detecting input and output data types of workflow functions of the one or more AI agent workflows;
performing type conversions between outputs of the reasoning model and the input data types of the workflow functions; and
transforming the output data types of the workflow functions.

8. The one or more processors of claim 1, wherein the operations comprise:
wrapping an individual function within the one or more AI agent workflows with reasoning capabilities;
detecting that the individual function has been wrapped with reasoning capabilities;
generating a prompt for the reasoning model that includes a description of the individual function to generate the execution plan for the individual function; and
causing selective application of reasoning to specific workflow components of the one or more AI agent workflows.

9. The one or more processors of claim 8, wherein the operations comprise:
providing configuration options for applying reasoning at multiple levels of workflow hierarchy of the one or more AI agent workflows.

10. The one or more processors of claim 1, wherein the operations comprise:
processing one or more configuration files that specify reasoning wrapper parameters without additional programming for the one or more AI agent workflows;
parsing configuration syntax of the one or more configuration files to select a portion of workflow components of the one or more AI agent workflows for reasoning; and
applying reasoning wrappers automatically at runtime to the portion of the workflow components before executing operations of the one or more AI agent workflows.

11. The one or more processors of claim 10, wherein the operations comprise:
monitoring execution of the execution plan by the one or more AI agent workflows;
detecting execution results comprising one or more errors or failures during execution of the execution plan;
generating feedback data comprising the execution results; and
providing feedback to the reasoning model for improving subsequent plan generation.

12. The one or more processors of claim 10, wherein the operations comprise:
implementing a validation model to check logical consistency of the execution plan before execution of the execution plan by the one or more AI agent workflows begins;
analyzing the execution plan for non-sequitur elements or logical errors; and
routing one or more invalid portions of the execution plan back to the reasoning model to generate a revised execution plan.

13. The one or more processors of claim 10, wherein the operations comprise:
building one or more behavioral profiles of the one or more AI agent workflows through continuous monitoring of execution patterns;
analyzing historical performance data to identify one or more common failure scenarios or one or more bottlenecks of the one or more AI agent workflows; and
incorporating the one or more behavioral profiles and the historical performance data into prompt construction for the reasoning model to generate the execution plan.

14. The one or more processors of claim 1, wherein the execution plan comprises:
a structured execution sequence of actionable steps that break down the user request into specific tasks to be executed by the one or more AI agent workflows;
a list of tools or functions to be called at a plurality of steps of the execution sequence along with corresponding input parameters;
instructions for tool invocations including specific input types and expected outputs for each step in the execution plan;
an order of execution steps and dependencies between different workflow components to accomplish the user request; and
a roadmap that enables instruction-following models to execute the execution plan.

15. The one or more processors of claim 1, wherein the reasoning model comprises a language model (LM).

16. The one or more processors of claim 1, wherein the one or more processors are comprised in at least one of:
a control system for an autonomous or semi-autonomous machine;
a perception system for the autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational artificial intelligence (AI) operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system incorporating one or more machine learning models deployed in a service or microservice along with an OS-level virtualization package;
a system implemented at least partially in a data center; or
a system implemented at least partially using cloud computing resources.

17. A system comprising one or more processors to perform operations comprising:
receiving, by an artificial intelligence (AI) agent system, one or more function descriptions corresponding to one or more functions available to one or more AI agent workflows;
instructing, by the AI agent system, a reasoning model to generate an execution plan for a user request based at least on the one or more function descriptions corresponding to the one or more functions available to the one or more AI agent workflows; and
causing the one or more AI agent workflows to process the user request by invoking at least one function of the one or more functions according to the execution plan.

18. The system of claim 17, wherein the system is comprised in at least one of:
a control system for an autonomous or semi-autonomous machine;
a perception system for the autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational artificial intelligence (AI) operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system incorporating one or more machine learning models deployed in a service or microservice along with an OS-level virtualization package;
a system implemented at least partially in a data center; or
a system implemented at least partially using cloud computing resources.

19. A method comprising:
receiving, by an artificial intelligence (AI) agent system, one or more function descriptions corresponding to one or more functions available to one or more AI agent workflows;
instructing, by the AI agent system, a reasoning model to generate an execution plan for a user request based at least on the one or more function descriptions corresponding to the one or more functions available to the one or more AI agent workflows; and
causing the one or more AI agent workflows to process the user request by invoking at least one function of the one or more functions according to the execution plan.

20. The method of claim 19, wherein the method is performed by at least one of:
a control system for an autonomous or semi-autonomous machine;
a perception system for the autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational artificial intelligence (AI) operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system incorporating one or more machine learning models deployed in a service or microservice along with an OS-level virtualization package;
a system implemented at least partially in a data center; or
a system implemented at least partially using cloud computing resources.
